(19) United States
(12) Patent Application Publication
(10) Pub. No.: US 2020/0374063 A1
(43) Pub. Date: Nov. 26, 2020

(54) RESOURCE ALLOCATION METHOD AND RELATED DEVICE

(71) Applicant: HUAWEI TECHNOLOGIES CO., LTD., Shenzhen (CN)

(72) Inventors: Yue ZHAO, Beijing (CN); Zheng YU, Beijing (CN)

(21) Appl. No.: 16/991,900

(22) Filed: Aug. 12, 2020

Related U.S. Application Data
(63) Continuation of application No. PCT/CN2018/076773, filed on Feb. 13, 2018.

(51) Int. Cl. H04L 5/00; H04W 72/04

(52) U.S. Cl. CPC H04L 5/0046; H04L 5/0051; H04W 72/0453; H04W 72/042

(57) ABSTRACT

Embodiments of the present application disclose a resource allocation method and a related device. A downlink control information is determined by a network device. The downlink control information includes a resource allocation information. The resource allocation information indicates a resource allocated to a terminal device. The downlink control information is sent by the network device to the terminal device. Data sent by the terminal device on the resource allocated to the terminal device are received by the network device.

### CROSS-REFERENCE TO RELATED APPLICATIONS

This application is a continuation of International Application No. PCT/CN2018/076773, filed on Feb. 13, 2018, the disclosure of which is hereby incorporated by reference in its entirety.

### TECHNICAL FIELD

This application relates to the field of communications technologies, and in particular, to a resource allocation method and a related device.

### BACKGROUND

Machine type communication (MTC) means that various devices having specific sensing, computing, execution, and communication capabilities are deployed to obtain information about a physical world, and information transmission, coordination, and processing are implemented through a network, to implement interconnection between people and things and interconnection between things and things. Currently, release (Rel)-12, Rel-13, Rel-14, and Rel-15 of long term evolution (long term evolution, LTE) can support MTC services.

In an LTE system, a resource is divided into subcarriers in frequency domain, and is divided into subframes in time domain. One subframe includes two slots. When a subcarrier spacing is 15 kHz, one physical resource block (PRB) includes 12 subcarriers in frequency domain, and includes one slot in time domain.

In LTE Rel-13, user equipment (UE) that can support an MTC service is bandwidth-reduced low-complexity UE (BL UE) or coverage enhancement UE (CE UE). The UE can support a maximum of 1.4 MHz transmit/receive bandwidth, including a narrowband. One narrowband includes a frequency width of six consecutive PRBs in frequency domain.

In LTE Rel-13, two coverage enhancement modes are provided for the coverage enhancement UE: a coverage enhancement mode A (CE mode A) used for a relatively small coverage enhancement degree and a coverage enhancement mode B (CE mode B) used for a relatively large coverage enhancement degree. To enable the MTC to support a higher data rate, in LTE Rel-14, a bandwidth that is used to transmit service data and that can be supported by the UE performing the MTC service is extended. In the CE mode A, a bandwidth of a physical uplink shared channel (PUSCH) supported by the UE is extended to 5 MHz. The PUSCH is used to carry uplink data of the UE.

In the LTE system, a frequency domain resource used by the PUSCH is allocated by using downlink control information (DCI). The DCI is sent by a base station to the UE. For the BL/CE UE, the DCI is carried on a machine type communication (MTC) physical downlink control channel (MPDCCH). In Rel-14 and earlier releases, a minimum of one resource block is allocated to the PUSCH during resource allocation. To improve spectral efficiency of the PUSCH, allocating a resource fewer than 12 subcarriers to the PUSCH is one of effective technical means that may be used.

In Rel-14 and the earlier releases, resource allocation information in the DCI carried on the MPDCCH can only indicate that a granularity of resource allocation is one PRB. To enable the DCI carried on the MPDCCH to indicate resource allocation of fewer than 12 subcarriers, a new resource allocation method needs to be designed.

### SUMMARY

Embodiments of the present application disclose a resource allocation method and a related device, so that resource allocation information in DCI can support resource allocation of fewer than 12 subcarriers.

According to a first aspect, an embodiment of this application provides a resource allocation method, where the method includes: determining, by a network device, downlink control information, where the downlink control information includes resource allocation information, and the resource allocation information indicates a resource allocated to a terminal device; sending, by the network device, the downlink control information to the terminal device; and receiving, by the network device on the resource allocated to the terminal device, data sent by the terminal device.

It can be learned that the network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes five bits, and the five bits have 32 bit states, where the 32 bit states include six bit states, and each of the six bit states indicates that one resource block in the narrowband is allocated to the terminal device; and/or the 32 bit states further include two bit states, and each of the two bit states indicates that two resource blocks in the narrowband are allocated to the terminal device; and/or the 32 bit states further include eight bit states, each of the eight bit states indicates that six subcarriers in a physical resource block m are allocated to the terminal device, and the physical resource block m is one of four physical resource blocks configured by using higher layer signaling; and/or the 32 bit states further include 16 bit states, each of the 16 bit states indicates that three subcarriers in a physical resource block x are allocated to the terminal device, and the physical resource block x is one of the four physical resource blocks configured by using the higher layer signaling.

It can be learned that the network device indicates, by using the bits, a location that is of the allocated resource and that is in the narrowband, and then indicates the

$$⌈ {log}_{2} ⌊ \frac{{N}_{RB}^{UL}}{6} ⌋ ⌉$$

bit states by using the other five bits. The 32 bit states correspond to six states about allocating one resource block, two states about allocating two resource blocks, eight states about allocating six subcarriers, and 16 states about allocating three subcarriers.

Optionally, the resource allocation information includes five bits, and the five bits have 32 bit states, where the 32 bit states include six bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the six bit states indicates that one resource block in the narrowband is allocated to user equipment; and/or the 32 bit states further include two bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the two bit states indicates that two resource blocks in the narrowband are allocated to the user equipment; and/or the 32 bit states further include eight bit states, each of the eight bit states indicates that six subcarriers in a physical resource block m are allocated to the user equipment, the physical resource block m is one of four physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 16 bit states, each of the 16 bit states indicates that three subcarriers in a physical resource block x are allocated to the user equipment, the physical resource block x is one of the four physical resource blocks configured by using the higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros. Herein, N_{RB}^{UL} represents a quantity of uplink RBs corresponding to a system bandwidth, ┌ ┐ represents rounding up, and └ ┘ represents rounding down.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes six bits, and the six bits have 64 bit states, where the 64 bit states include six bit states, and each of the six bit states indicates that one resource block in the narrowband is allocated to user equipment; and/or the 64 bit states further include two bit states, and each of the two bit states indicates that two resource blocks in the narrowband are allocated to the user equipment; and/or the 64 bit states further include 12 bit states, each of the 12 bit states indicates that six subcarriers in a physical resource block k are allocated to the user equipment, and the physical resource block k is a resource block in the narrowband; and/or the 64 bit states further include 24 bit states, each of the 24 bit states indicates that three subcarriers in a physical resource block p are allocated to the user equipment, and the physical resource block p is a resource block in the narrowband.

Optionally, the resource allocation information further includes six bits, and the six bits have 64 bit states, where the 64 bit states include six bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the six bit states indicates that one resource block in the narrowband is allocated to user equipment; and/or the 64 bit states further include two bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the two bit states indicates that two resource blocks in the narrowband are allocated to the user equipment; and/or the 64 bit states further include 12 bit states, each of the 12 bit states indicates that six subcarriers in a physical resource block k are allocated to the user equipment, the physical resource block k is one of six physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 24 bit states, each of the 24 bit states indicates that three subcarriers in a physical resource block y are allocated to the user equipment, the physical resource block y is one of the six physical resource blocks configured by using the higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros. Herein, N_{RB}^{UL} represents a quantity of uplink RBs corresponding to a system bandwidth, ┌ ┐ represents rounding up, and └ ┘ represents rounding down.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes six bits, and the six bits have 64 bit states, where the 64 bit states include 21 bit states, and the 21 bit states indicate, to user equipment, a resource allocation granularity of one resource block and resource allocation in the narrowband; and/or the 64 bit states further include 12 bit states, each of the 12 bit states indicates that six subcarriers in a physical resource block m are allocated to the user equipment, and the physical resource block m is a resource block in the narrowband; and/or the 64 bit states further include 24 bit states, each of the 24 bit states indicates that three subcarriers in a physical resource block x are allocated to the user equipment, and the physical resource block x is a resource block in the narrowband.

Optionally, the resource allocation information includes six bits, and the six bits have 64 bit states, where the 64 bit states include 21 bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and the 21 bit states indicate, to user equipment, a resource allocation granularity of one resource block and resource allocation in the narrowband; and/or the 64 bit states further include 12 bit states, each of the 12 bit states indicates that six subcarriers in a physical resource block k are allocated to the user equipment, the physical resource block k is one of six physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 24 bit states, each of the 24 bit states indicates that three subcarriers in a physical resource blocky are allocated to the user equipment, the physical resource blocky is one of the six physical resource blocks configured by using the higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros. Herein, N_{RB}^{UL} represents a quantity of uplink RBs corresponding to a system bandwidth, ┌ ┐ represents rounding up, and represents rounding down.

Optionally, the four physical resource blocks configured by using the higher layer signaling are four physical resource blocks in the narrowband indicated by the narrowband index. Alternatively, the four physical resource blocks configured by using the higher layer signaling are any four physical resource blocks configured in the system bandwidth. The four configured physical resource blocks are indicated to the user equipment by using radio resource control information signaling or media access control signaling.

Optionally, the six physical resource blocks configured by using the higher layer signaling are six physical resource blocks in the narrowband indicated by the narrowband index. Alternatively, the six physical resource blocks are any six physical resource blocks configured in the system bandwidth. The six configured physical resource blocks are indicated to the user equipment by using radio resource control information signaling or media access control signaling.

According to a second aspect, an embodiment of this application provides a resource allocation method, where the method includes: receiving, by a terminal device, downlink control information, where the downlink control information includes resource allocation information, and the resource allocation information indicates a resource allocated to the terminal device; and sending, by the terminal device, data on the resource indicated in the downlink control information.

It can be learned that the terminal device receives the downlink control information. The terminal device determines, based on the resource allocation information included in the downlink control information, the resource allocated by the network device. The terminal device sends the data on the resource allocated by the network device.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes five bits, and the five bits have 32 bit states, where the 32 bit states include six bit states, and each of the six bit states indicates that one resource block in the narrowband is allocated to the terminal device; and/or the 32 bit states further include two bit states, and each of the two bit states indicates that two resource blocks in the narrowband are allocated to the terminal device; and/or the 32 bit states further include eight bit states, each of the eight bit states indicates that six subcarriers in a physical resource block m are allocated to the terminal device, and the physical resource block m is one of four physical resource blocks configured by using higher layer signaling; and/or the 32 bit states further include 16 bit states, each of the 16 bit states indicates that three subcarriers in a physical resource block x are allocated to the terminal device, and the physical resource block x is one of the four physical resource blocks configured by using the higher layer signaling.

It can be learned that the network device indicates, by using the

$$⌈ {log}_{2} ⌊ \frac{{N}_{RB}^{UL}}{6} ⌋ ⌉$$

bits, a location that is of the allocated resource and that is in the narrowband, and then indicates the 32 bit states by using the other five bits. The 32 bit states correspond to six states about allocating one resource block, two states about allocating two resource blocks, eight states about allocating six subcarriers, and 16 states about allocating three subcarriers.

Optionally, the resource allocation information includes five bits, and the five bits have 32 bit states, where the 32 bit states include six bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the six bit states indicates that one resource block in the narrowband is allocated to user equipment; and/or the 32 bit states further include two bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the two bit states indicates that two resource blocks in the narrowband are allocated to the user equipment; and/or the 32 bit states further include eight bit states, each of the eight bit states indicates that six subcarriers in a physical resource block m are allocated to the user equipment, the physical resource block m is one of four physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 16 bit states, each of the 16 bit states indicates that three subcarriers in a physical resource block x are allocated to the user equipment, the physical resource block x is one of the four physical resource blocks configured by using the higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros. Herein, N_{RB}^{UL} represents a quantity of uplink RBs corresponding to a system bandwidth, ┌ ┐ represents rounding up, and └ ┘ represents rounding down.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes six bits, and the six bits have 64 bit states, where the 64 bit states include six bit states, and each of the six bit states indicates that one resource block in the narrowband is allocated to user equipment; and/or the 64 bit states further include two bit states, and each of the two bit states indicates that two resource blocks in the narrowband are allocated to the user equipment; and/or the 64 bit states further include 12 bit states, each of the 12 bit states indicates that six subcarriers in a physical resource block k are allocated to the user equipment, and the physical resource block k is a resource block in the narrowband; and/or the 64 bit states further include 24 bit states, each of the 24 bit states indicates that three subcarriers in a physical resource block p are allocated to the user equipment, and the physical resource block p is a resource block in the narrowband.

Optionally, the resource allocation information further includes six bits, and the six bits have 64 bit states, where the 64 bit states include six bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the six bit states indicates that one resource block in the narrowband is allocated to user equipment; and/or the 64 bit states further include two bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the two bit states indicates that two resource blocks in the narrowband are allocated to the user equipment; and/or the 64 bit states further include 12 bit states, each of the 12 bit states indicates that six subcarriers in a physical resource block k are allocated to the user equipment, the physical resource block k is one of six physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 24 bit states, each of the 24 bit states indicates that three subcarriers in a physical resource block y are allocated to the user equipment, the physical resource block y is one of the six physical resource blocks configured by using the higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros. Herein, N_{RB}^{UL} represents a quantity of uplink RBs corresponding to a system bandwidth, ┌ ┐ represents rounding up, and └ ┘ represents rounding down.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes six bits, and the six bits have 64 bit states, where the 64 bit states include 21 bit states, and the 21 bit states indicate, to user equipment, a resource allocation granularity of one resource block and resource allocation in the narrowband; and/or the 64 bit states further include 12 bit states, each of the 12 bit states indicates that six subcarriers in a physical resource block m are allocated to the user equipment, and the physical resource block m is a resource block in the narrowband; and/or the 64 bit states further include 24 bit states, each of the 24 bit states indicates that three subcarriers in a physical resource block x are allocated to the user equipment, and the physical resource block x is a resource block in the narrowband.

Optionally, the resource allocation information includes six bits, and the six bits have 64 bit states, where the 64 bit states include 21 bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and the 21 bit states indicate, to user equipment, a resource allocation granularity of one resource block and resource allocation in the narrowband; and/or the 64 bit states further include 12 bit states, each of the 12 bit states indicates that six subcarriers in a physical resource block k are allocated to the user equipment, the physical resource block k is one of six physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 24 bit states, each of the 24 bit states indicates that three subcarriers in a physical resource blocky are allocated to the user equipment, the physical resource blocky is one of the six physical resource blocks configured by using the higher layer signaling, the resource allocation information further includes

$$⌈ {log}_{2} ⌊ \frac{{N}_{RB}^{UL}}{6} ⌋ ⌉$$

bits, and states of

$$⌈ {log}_{2} ⌊ \frac{{N}_{RB}^{UL}}{6} ⌋ ⌉$$

the bits are set to all ones or all zeros. Herein, N_{RB}^{UL} represents a quantity of uplink RBs corresponding to a system bandwidth, ┌ ┐ represents rounding up, and └ ┘ represents rounding down.

Optionally, the four physical resource blocks configured by using the higher layer signaling are four physical resource blocks in the narrowband indicated by the narrowband index. Alternatively, the four physical resource blocks configured by using the higher layer signaling are any four physical resource blocks configured in the system bandwidth. The four configured physical resource blocks are indicated to the user equipment by using radio resource control information signaling or media access control signaling.

Optionally, the six physical resource blocks configured by using the higher layer signaling are six physical resource blocks in the narrowband indicated by the narrowband index. Alternatively, the six physical resource blocks are any six physical resource blocks configured in the system bandwidth. The six configured physical resource blocks are indicated to the user equipment by using radio resource control information signaling or media access control signaling.

According to a third aspect, a network device is provided. The network device may perform the method in the first aspect or the possible implementations of the first aspect. The functions may be implemented by hardware, or may be implemented by hardware by executing corresponding software. The hardware or the software includes one or more units corresponding to the functions. The unit may be software and/or hardware. Based on a same inventive concept, for a problem-resolving principle and beneficial effects of the network device, refer to the principle and the beneficial effects of the first aspect or the possible implementations of the first aspect. No repeated description is provided.

According to a fourth aspect, a terminal device is provided. The terminal device may perform the method in the second aspect or the possible implementations of the second aspect. The functions may be implemented by hardware, or may be implemented by hardware by executing corresponding software. The hardware or the software includes one or more units corresponding to the functions. The unit may be software and/or hardware. Based on a same inventive concept, for a problem-resolving principle and beneficial effects of the terminal device, refer to the principle and the beneficial effects of the second aspect or the possible implementations of the second aspect. No repeated description is provided.

According to a fifth aspect, a network device is provided, where the network device includes a processor, a memory, and a communications interface. The processor, the communications interface, and the memory are connected to each other. The communications interface may be a transceiver. The communications interface is configured to implement communication with another network element (for example, a terminal device). One or more programs are stored in the memory. The processor invokes the program stored in the memory to implement the solution in the first aspect or the possible implementations of the first aspect. For a problem-resolving implementation and beneficial effects of the network device, refer to the principle and beneficial effects of the first aspect or the possible implementations of the first aspect. No repeated description is provided.

According to a sixth aspect, a terminal device is provided, where the terminal device includes a processor, a memory, and a communications interface. The processor, the communications interface, and the memory are connected to each other. The communications interface may be a transceiver. The communications interface is configured to implement communication with another network element (for example, a terminal device). One or more programs are stored in the memory. The processor invokes the program stored in the memory to implement the solution in the second aspect or the possible implementations of the second aspect. For a problem-resolving implementation and beneficial effects of the terminal device, refer to the principle and beneficial effects of the second aspect or the possible implementations of the second aspect. No repeated description is provided.

According to a seventh aspect, a computer program product is provided. When the computer program product runs on a computer, the computer is enabled to perform the method in the first aspect, the second aspect, the possible implementations of the first aspect, or the possible implementations of the second aspect.

According to an eighth aspect, a chip product of a network device is provided, to perform the method in the first aspect or the possible implementations of the first aspect.

According to a ninth aspect, a chip product of a terminal device is provided, to perform the method in the second aspect or the possible implementations of the second aspect.

According to a tenth aspect, a computer-readable storage medium is provided. The computer-readable storage medium stores an instruction. When the instruction is run on a computer, the computer is enabled to perform the method in the first aspect, the second aspect, the possible implementations of the first aspect, or the possible implementations of the second aspect.

### BRIEF DESCRIPTION OF DRAWINGS

FIG. 1 is a schematic structural diagram of a communications system according to an embodiment of the present application;

FIG. 2 is a schematic flowchart of a resource allocation method according to an embodiment of the present application;

FIG. 3 is a schematic flowchart of a resource allocation method according to an embodiment of the present application;

FIG. 4 is a schematic structural diagram of a network device according to an embodiment of the present application; and

FIG. 5 is a schematic structural diagram of a terminal device according to an embodiment of the present application.

### DESCRIPTION OF EMBODIMENTS

The following describes technical solutions in embodiments of the present application with reference to accompanying drawings.

For a terminal device in a coverage enhancement mode B, in the existing LTE, a DCI format 6-0B is used to schedule a PUSCH. More specifically, in the LTE, the DCI format 6-0B is used to indicate information of the PUSCH such as resource allocation and a modulation and coding scheme. A resource block allocation field in the existing DCI format 6-0B includes

$$⌈ {log}_{2} ⌊ \frac{{N}_{RB}^{UL}}{6} ⌋ ⌉ + 3$$

bits, where N_{RB}^{UL} represents a quantity of uplink PRBs included in a system bandwidth, └ ┘ represents a rounding down operation, and ┌ ┐ represents a rounding up operation.

For a terminal device in a coverage enhancement mode A, in the existing LTE, a DCI format 6-0A is used to schedule a PUSCH. More specifically, in the LTE, the DCI format 6-0A is used to indicate information of the PUSCH such as resource allocation and a modulation and coding scheme. A resource block allocation field in the existing DCI format 6-0A includes

$$⌈ {log}_{2} ⌊ \frac{{N}_{RB}^{UL}}{6} ⌋ ⌉ + 5$$

bits, where N_{RB}^{UL} represents a quantity of uplink PRBs included in a system bandwidth, └ ┘ represents a rounding down operation, and ┌ ┐ represents a rounding up operation.

In the existing DCI format 6-0B/A, a bit used for resource block allocation indicates that an allocated frequency resource of the PUSCH includes one or more resource blocks. The resource block described in this specification is a physical resource block, namely, a PRB. To improve spectral efficiency of the PUSCH, a frequency resource that is of the PUSCH and that is fewer than 12 subcarriers needs to be allocated to the terminal device, in other words, a frequency resource of the PUSCH is allocated in a minimum unit of one subcarrier. One resource block includes 12 subcarriers in frequency domain. To enable the DCI to indicate resource allocation of fewer than 12 subcarriers, a new resource allocation method needs to be designed.

Therefore, embodiments of this application provide a resource allocation method and a related device, so that the DCI can indicate the resource allocation of fewer than 12 subcarriers.

To better understand the embodiments of this application, the following describes a communications system to which the embodiments of this application can be applied.

This application may be applied to an LTE system or an evolved system of the LTE system. The present application may also be applied to another communications system, provided that the communications system includes that an entity (e.g., a network device) needs to send DCI to indicate resource allocation for communication with another entity (e.g., a terminal device), and the another entity (e.g., the terminal device) needs to analyze the DCI in a specific manner.

Optionally, the network device in the embodiments of this application is an entity that is on a network side and that is configured to send or receive a signal. For example, the network device may be an evolved NodeB (evolutional node B, eNB, or eNodeB) in the LTE system or a radio network controller in a cloud radio access network (CRAN), or may be an access network device in a 5G network, for example, a gNB, or may be a small cell, a micro base station, or a transmission reception point (TRP), or may be a relay station, an access point, an access network device in a future evolved public land mobile network (PLMN), or the like.

Alternatively, the network device may be a terminal device. In an embodiment, this application may be applied to a communications system. The communications system includes that a terminal device needs to send DCI to indicate resource allocation for communication with another terminal device, and the another terminal device needs to analyze the DCI in a specific manner. For example, the terminal device in this application may be an access terminal, user equipment (UE), a subscriber unit, a subscriber station, a mobile station, a mobile console, a remote station, a remote terminal, a mobile terminal, a user terminal, a terminal, a wireless network device, a user agent, or a user apparatus. The access terminal may be a cellular phone, a cordless phone, a session initiation protocol (SIP) phone, a wireless local loop (WLL) station, a personal digital assistant (PDA), a handheld device having a wireless communication function, a computing device, another processing device connected to a wireless modem, a vehicle-mounted device, a wearable device, a terminal device in an internet of things, a virtual reality device, a terminal device in a future 5G network, a terminal device in a future evolved public land mobile network (PLMN), UE performing an MTC service, BL UE, CE UE, or the like.

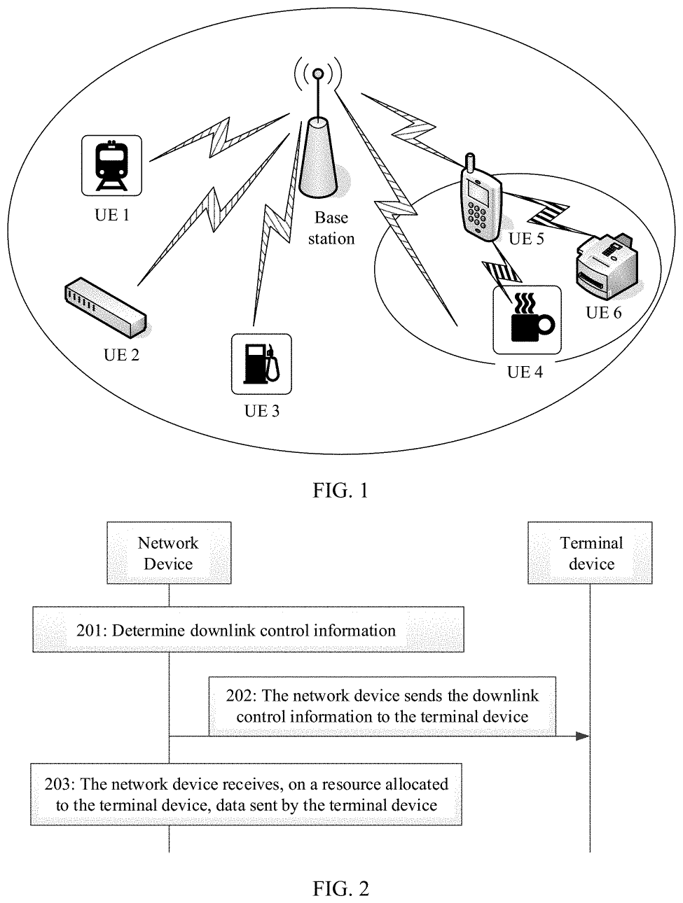

For example, FIG. 1 is a schematic diagram of a communications system according to an embodiment of this application. As shown in FIG. 1, the communications system may include seven network devices: a base station (Base station) and UE 1 to UE 6. In the communications system, the base station sends DCI to one or more of the UE 1 to the UE 6. The DCI is used to indicate resource allocation of a PUSCH of one or more of the UE 1 to the UE 6. Therefore, the network device in the embodiments of this application may be the base station, and the terminal device may be any one of the UE 1 to the UE 6.

For another example, as shown in FIG. 1, the UE 4 to the UE 6 may also form a communications system. In the communications system, the UE 5 may send DCI to one of or both the UE 4 and the UE 6. The DCI is used to indicate resource allocation of a PUSCH of one of or both the UE 4 and the UE 6. Therefore, the network device in the embodiments of this application may be the UE 5, and the terminal device may be either the UE 4 or the UE 6.

The following describes in detail the information indication method and the related device that are provided in this application.

FIG. 2 is a schematic flowchart of a resource allocation method according to an embodiment of this application. As shown in FIG. 2, the resource allocation method includes the following operations 201 to 203.

201: A network device determines downlink control information to be sent to a terminal device.

The network device may be a base station or a terminal device. For example, as shown in FIG. 1, when the network device is the base station, the terminal device is any one of the UE 1 to the UE 6. When the network device is the UE 5, the terminal device is either the UE 4 or the UE 6. A PUSCH is used to carry uplink data of the terminal device.

That the network device determines the downlink control information is that the network device determines the downlink control information that needs to be sent to the terminal device.

202: The network device sends the downlink control information to the terminal device.

203: The network device receives, on a resource allocated to the terminal device, data sent by the terminal device.

It should be noted that in an embodiment of the application, because the downlink control information includes indication information and resource allocation information, before sending the downlink control information to the terminal device, the network device may determine, in the following at least two possible implementations, the indication information and the resource allocation information included in the downlink control information.

In a first possible implementation, for a terminal device in a coverage enhancement mode B, an example in which the resource allocation information includes

$$⌈ {log}_{2} ⌊ \frac{{N}_{RB}^{UL}}{6} ⌋ ⌉ + 5$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes five bits, and the five bits have 32 bit states, where the 32 bit states include six bit states, and each of the six bit states indicates that one resource block in the narrowband is allocated to the terminal device; and/or the 32 bit states further include two bit states, and each of the two bit states indicates that two resource blocks in the narrowband are allocated to the terminal device; and/or the 32 bit states further include eight bit states, each of the eight bit states indicates that six subcarriers in a physical resource block m are allocated to the terminal device, and the physical resource block m is one of four physical resource blocks configured by using higher layer signaling; and/or the 32 bit states further include 16 bit states, each of the 16 bit states indicates that three subcarriers in a physical resource block x are allocated to the terminal device, and the physical resource block x is one of the four physical resource blocks configured by using the higher layer signaling.

Optionally, the four physical resource blocks configured by using the higher layer signaling are four physical resource blocks in the narrowband.

It can be learned that the network device indicates, by using the

$$⌈ {log}_{2} ⌊ \frac{{N}_{RB}^{UL}}{6} ⌋ ⌉$$

bits, a location that is of the allocated resource and that is in the narrowband, and then indicates the 32 bit states by using the other five bits. The 32 bit states correspond to six states about allocating one resource block, two states about allocating two resource blocks, eight states about allocating six subcarriers, and 16 states about allocating three subcarriers.

For example, a mapping relationship between the 32 bit states and a resource allocation may meet Table 1. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are four resource blocks that are configured by using the higher layer signaling and that are in the PRB n, the PRB n+1, the PRB n+2, the PRB n+3, the PRB n+4, and the PRB n+5. Herein, n is an integer greater than or equal to 0; n, n+1, n+2, n+3, n+4, and n+5 represent indexes of PRBs; m1 to m4 are integers greater than or equal to 0; and m1, m2, m3, and m4 represent indexes of PRBs.

TABLE 1

| States | | States | |
|---|---|---|---|
| indicated | | indicated | |
| by five bits | Allocated resource | by five bits | Allocated resource |
| 00000 | PRB n | 10000 | Subcarriers 6, 7, and |
| | | | 8 in the PRB m2 |
| 00001 | PRB n + 1 | 10001 | Subcarriers 9, 10, and |
| | | | 11 in the PRB m2 |
| 00010 | PRB n + 2 | 10010 | Subcarriers 0, 1, 2, 3, |
| | | | 4, and 5 in the PRB |
| | | | m2 |
| 00011 | PRB n + 3 | 10011 | Subcarriers 6, 7, 8, 9, |
| | | | 10, and 11 in the PRB |
| | | | m2 |
| 00100 | PRB n + 4 | 10100 | Subcarriers 0, 1, and |
| | | | 2 in the PRB m3 |
| 00101 | PRB n + 5 | 10101 | Subcarriers 3, 4, and |
| | | | 5 in the PRB m3 |
| 00110 | PRB n and | 10110 | Subcarriers 6, 7, and |
| | PRB n + 1 | | 8 in the PRB m3 |
| 00111 | PRB n + 2 and | 10111 | Subcarriers 9, 10, and |
| | PRB n + 3 | | 11 in the PRB m3 |
| 01000 | Subcarriers 0, 1, and | 11000 | Subcarriers 0, 1, 2, 3, |
| | 2 in the PRB m1 | | 4, and 5 in the PRB |
| | | | m3 |
| 01001 | Subcarriers 3, 4, and | 11001 | Subcarriers 6, 7, 8, 9, |
| | 5 in the PRB m1 | | 10, and 11 in the PRB |
| | | | m3 |
| 01010 | Subcarriers 6, 7, and | 11010 | Subcarriers 0, 1, and |
| | 8 in the PRB m1 | | 2 in the PRB m4 |
| 01011 | Subcarriers 9, 10, and | 11011 | Subcarriers 3, 4, and |
| | 11 in the PRB m1 | | 5 in the PRB m4 |
| 01100 | Subcarriers 0, 1, 2, 3, | 11100 | Subcarriers 6, 7, and |
| | 4, and 5 in the PRB | | 8 in the PRB m4 |
| | m1 | | |
| 01101 | Subcarriers 6, 7, 8, 9, | 11101 | Subcarriers 9, 10, and |
| | 10, and 11 in the PRB | | 11 in the PRB m4 |
| | m1 | | |
| 01110 | Subcarriers 0, 1, and | 11110 | Subcarriers 0, 1, 2, 3, |
| | 2 in the PRB m2 | | 4, and 5 in the PRB |
| | | | m4 |
| 01111 | Subcarriers 3, 4, and | 11111 | Subcarriers 6, 7, 8, 9, |
| | 5 in the PRB m2 | | 10, and 11 in the PRB |
| | | | m4 |

For example, a mapping relationship between the 32 bit states and a resource allocation may alternatively meet Table 2. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are four resource blocks that are configured by using the higher layer signaling and that are in the PRB n, the PRB n+1, the PRB n+2, the PRB n+3, the PRB n+4, and the PRB n+5. Herein, n is an integer greater than or equal to 0; n, n+1, n+2, n+3, n+4, and n+5 represent indexes of PRBs; m1 to m4 are integers greater than or equal to 0; and m1, m2, m3, and m4 represent indexes of PRBs.

TABLE 2

| States | | States | |
|---|---|---|---|
| indicated | | indicated | |
| by five bits | Allocated resource | by five bits | Allocated resource |
| 00000 | Subcarriers 0, 1, and | 10000 | Subcarriers 0, 1, 2, 3, |
| | 2 in the PRB m1 | | 4, and 5 in the PRB |
| | | | m3 |
| 00001 | Subcarriers 3, 4, and | 10001 | Subcarriers 6, 7, 8, 9, |
| | 5 in the PRB m1 | | 10, and 11 in the PRB |
| | | | m3 |
| 00010 | Subcarriers 6, 7, and | 10010 | Subcarriers 0, 1, and |
| | 8 in the PRB m1 | | 2 in the PRB m4 |
| 00011 | Subcarriers 9, 10, | 10011 | Subcarriers 3, 4, and |
| | and 11 in the PRB | | 5 in the PRB m4 |
| | m1 | | |
| 00100 | Subcarriers 0, 1, 2, 3, | 10100 | Subcarriers 6, 7, and |
| | 4, and 5 in the PRB | | 8 in the PRB m4 |
| | m1 | | |
| 00101 | Subcarriers 6, 7, 8, 9, | 10101 | Subcarriers 9, 10, and |
| | 10, and 11 in the | | 11 in the PRB m4 |
| | PRB m1 | | |
| 00110 | Subcarriers 0, 1, and | 10110 | Subcarriers 0, 1, 2, 3, |
| | 2 in the PRB m2 | | 4, and 5 in the PRB |
| | | | m4 |
| 00111 | Subcarriers 3, 4, and | 10111 | Subcarriers 6, 7, 8, 9, |
| | 5 in the PRB m2 | | 10, and 11 in the PRB |
| | | | m4 |
| 01000 | Subcarriers 6, 7, and | 11000 | PRB n |
| | 8 in the PRB m2 | | |
| 01001 | Subcarriers 9, 10, | 11001 | PRB n + 1 |
| | and 11 in the PRB | | |
| | m2 | | |
| 01010 | Subcarriers 0, 1, 2, 3, | 11010 | PRB n + 2 |
| | 4, and 5 in the PRB | | |
| | m2 | | |
| 01011 | Subcarriers 6, 7, 8, 9, | 11011 | PRB n + 3 |
| | 10, and 11 in the | | |
| | PRB m2 | | |
| 01100 | Subcarriers 0, 1, and | 11100 | PRB n + 4 |
| | 2 in the PRB m3 | | |
| 01101 | Subcarriers 3, 4, and | 11101 | PRB n + 5 |
| | 5 in the PRB m3 | | |
| 01110 | Subcarriers 6, 7, and | 11110 | PRB n and PRB n + 1 |
| | 8 in the PRB m3 | | |
| 01111 | Subcarriers 9, 10, | 11111 | PRB n + 2 and PRB |
| | and 11 in the PRB | | n + 3 |
| | m3 | | |

For example, a mapping relationship between the 32 bit states and a resource allocation may alternatively meet Table 3. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are four resource blocks that are configured by using the higher layer signaling and that are in the PRB n, the PRB n+1, the PRB n+2, the PRB n+3, the PRB n+4, and the PRB n+5. Herein, n is an integer greater than or equal to 0; n, n+1, n+2, n+3, n+4, and n+5 represent indexes of PRBs; m1 to m4 are integers greater than or equal to 0; and m1, m2, m3, and m4 represent indexes of PRBs.

TABLE 3

| States | | States | |
|---|---|---|---|
| indicated | | indicated | |
| by five bits | Allocated resource | by five bits | Allocated resource |
| 00000 | PRB n | 10000 | Subcarriers 0, 1, and |
| | | | 2 in the PRB m1 |
| 00001 | PRB n + 1 | 10001 | Subcarriers 3, 4, and |
| | | | 5 in the PRB m1 |
| 00010 | PRB n + 2 | 10010 | Subcarriers 6, 7, and |
| | | | 8 in the PRB m1 |
| 00011 | PRB n + 3 | 10011 | Subcarriers 9, 10, and |
| | | | 11 in the PRB m1 |
| 00100 | PRB n + 4 | 10100 | Subcarriers 0, 1, and |
| | | | 2 in the PRB m2 |
| 00101 | PRB n + 5 | 10101 | Subcarriers 3, 4, and |
| | | | 5 in the PRB m2 |
| 00110 | PRB n and PRB n + 1 | 10110 | Subcarriers 6, 7, and |
| | | | 8 in the PRB m2 |
| 00111 | PRB n + 2 and PRB | 10111 | Subcarriers 9, 10, and |
| | n + 3 | | 11 in the PRB m2 |
| 01000 | Subcarriers 0, 1, 2, 3, | 11000 | Subcarriers 0, 1, and |
| | 4, and 5 in the PRB | | 2 in the PRB m3 |
| | m1 | | |
| 01001 | Subcarriers 6, 7, 8, 9, | 11001 | Subcarriers 3, 4, and |
| | 10, and 11 in the | | 5 in the PRB m3 |
| | PRB m1 | | |
| 01010 | Subcarriers 0, 1, 2, 3, | 11010 | Subcarriers 6, 7, and |
| | 4, and 5 in the PRB | | 8 in the PRB m3 |
| | m2 | | |
| 01011 | Subcarriers 6, 7, 8, 9, | 11011 | Subcarriers 9, 10, and |
| | 10, and 11 in the | | 11 in the PRB m3 |
| | PRB m2 | | |
| 01100 | Subcarriers 0, 1, 2, 3, | 11100 | Subcarriers 0, 1, and |
| | 4, and 5 in the PRB | | 2 in the PRB m4 |
| | m3 | | |
| 01101 | Subcarriers 6, 7, 8, 9, | 11101 | Subcarriers 3, 4, and |
| | 10, and 11 in the | | 5 in the PRB m4 |
| | PRB m3 | | |
| 01110 | Subcarriers 0, 1, 2, 3, | 11110 | Subcarriers 6, 7, and |
| | 4, and 5 in the PRB | | 8 in the PRB m4 |
| | m4 | | |
| 01111 | Subcarriers 6, 7, 8, 9, | 11111 | Subcarriers 9, 10, and |
| | 10, and 11 in the | | 11 in the PRB m4 |
| | PRB m4 | | |

For example, a mapping relationship between the 32 bit states and a resource allocation may alternatively meet Table 4. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are four resource blocks that are configured by using the higher layer signaling and that are in the PRB n, the PRB n+1, the PRB n+2, the PRB n+3, the PRB n+4, and the PRB n+5. Herein, n is an integer greater than or equal to 0; n, n+1, n+2, n+3, n+4, and n+5 represent indexes of PRBs; m1 to m4 are integers greater than or equal to 0; and m1, m2, m3, and m4 represent indexes of PRBs.

TABLE 4

| States | | States | |
|---|---|---|---|
| indicated | | indicated | |
| by five bits | Allocated resource | by five bits | Allocated resource |
| 00000 | Subcarriers 0, 1, 2, 3, | 10000 | Subcarriers 0, 1, and |
| | 4, and 5 in the PRB | | 2 in the PRB m3 |
| | m1 | | |
| 00001 | Subcarriers 6, 7, 8, 9, | 10001 | Subcarriers 3, 4, and |
| | 10, and 11 in the | | 5 in the PRB m3 |
| | PRB m1 | | |
| 00010 | Subcarriers 0, 1, 2, 3, | 10010 | Subcarriers 6, 7, and |
| | 4, and 5 in the PRB | | 8 in the PRB m3 |
| | m2 | | |
| 00011 | Subcarriers 6, 7, 8, 9, | 10011 | Subcarriers 9, 10, |
| | 10, and 11 in the | | and 11 in the PRB |
| | PRB m2 | | m3 |
| 00100 | Subcarriers 0, 1, 2, 3, | 10100 | Subcarriers 0, 1, and |
| | 4, and 5 in the PRB | | 2 in the PRB m4 |
| | m3 | | |
| 00101 | Subcarriers 6, 7, 8, 9, | 10101 | Subcarriers 3, 4, and |
| | 10, and 11 in the | | 5 in the PRB m4 |
| | PRB m3 | | |
| 00110 | Subcarriers 0, 1, 2, 3, | 10110 | Subcarriers 6, 7, and |
| | 4, and 5 in the PRB | | 8 in the PRB m4 |
| | m4 | | |
| 00111 | Subcarriers 6, 7, 8, 9, | 10111 | Subcarriers 9, 10, |
| | 10, and 11 in the | | and 11 in the PRB |
| | PRB m4 | | m4 |
| 01000 | Subcarriers 0, 1, and | 11000 | PRB n |
| | 2 in the PRB m1 | | |
| 01001 | Subcarriers 3, 4, and | 11001 | PRB n + 1 |
| | 5 in the PRB m1 | | |
| 01010 | Subcarriers 6, 7, and | 11010 | PRB n + 2 |
| | 8 in the PRB m1 | | |
| 01011 | Subcarriers 9, 10, | 11011 | PRB n + 3 |
| | and 11 in the PRB | | |
| | m1 | | |
| 01100 | Subcarriers 0, 1, and | 11100 | PRB n + 4 |
| | 2 in the PRB m2 | | |
| 01101 | Subcarriers 3, 4, and | 11101 | PRB n + 5 |
| | 5 in the PRB m2 | | |
| 01110 | Subcarriers 6, 7, and | 11110 | PRB n and PRB n + 1 |
| | 8 in the PRB m2 | | |
| 01111 | Subcarriers 9, 10, | 11111 | PRB n + 2 and PRB |
| | and 11 in the PRB | | n + 3 |
| | m2 | | |

It should be noted that Table 1 to Table 4 are merely examples for description, the six types indicate resource allocation of one PRB in the narrowband, the two types indicate resource allocation of two PRBs in the narrowband, the eight types indicate resource allocation of six subcarriers in one of four PRBs configured by using the higher layer signaling, and the 16 types indicate resource allocation of three subcarriers in one of the four PRBs configured by using the higher layer signaling. The resource allocation may be alternatively indicated based on another mapping relationship.

In a second possible implementation, for a terminal device in a coverage enhancement mode B, an example in which the resource allocation information includes

$$⌈ {log}_{2} ⌊ \frac{{N}_{RB}^{UL}}{6} ⌋ ⌉ + 5$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes five bits, and the five bits have 32 bit states, where the 32 bit states include six bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the six bit states indicates that one resource block in the narrowband is allocated to user equipment; and/or the 32 bit states further include two bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the two bit states indicates that two resource blocks in the narrowband are allocated to the user equipment; and/or the 32 bit states further include eight bit states, each of the eight bit states indicates that six subcarriers in a physical resource block m are allocated to the user equipment, the physical resource block m is one of four physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 16 bit states, each of the 16 bit states indicates that three subcarriers in a physical resource block x are allocated to the user equipment, the physical resource block x is one of the four physical resource blocks configured by using the higher layer signaling, the resource allocation information further includes

$$⌈ {log}_{2} ⌊ \frac{{N}_{R B}^{U L}}{6} ⌋ ⌉$$

bits, and states of the

$$⌈ {log}_{2} ⌊ \frac{{N}_{R B}^{U L}}{6} ⌋ ⌉$$

bits are set to all ones or all zeros. Herein, N_{RB}^{UL} represents a quantity of uplink RBs corresponding to a system bandwidth, ┌ ┐ represents rounding up, and └ ┘ represents rounding down.

Optionally, the four physical resource blocks configured by using the higher layer signaling are any four physical resource blocks configured in the system bandwidth.

For example, a mapping relationship between the 32 bit states and a resource allocation may meet Table 5. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are any four resource blocks in the system bandwidth that are configured by using the higher layer signaling. Herein, n is an integer greater than or equal to 0; n, n+1, n+2, n+3, n+4, and n+5 represent indexes of PRBs; m1 to m4 are integers greater than or equal to 0; and m1, m2, m3, and m4 represent indexes of PRBs.

TABLE 5

| States | | States | |
|---|---|---|---|
| indicated | | indicated | |
| by five bits | Allocated resource | by five bits | Allocated resource |
| 00000 | PRB n | 10000 | Subcarriers 6, 7, and |
| | | | 8 in the PRB m2 |
| 00001 | PRB n + 1 | 10001 | Subcarriers 9, 10, and |
| | | | 11 in the PRB m2 |
| 00010 | PRB n + 2 | 10010 | Subcarriers 0, 1, 2, 3, |
| | | | 4, and 5 in the PRB |
| | | | m2 |
| 00011 | PRB n + 3 | 10011 | Subcarriers 6, 7, 8, 9, |
| | | | 10, and 11 in the PRB |
| | | | m2 |
| 00100 | PRB n + 4 | 10100 | Subcarriers 0, 1, and |
| | | | 2 in the PRB m3 |
| 00101 | PRB n + 5 | 10101 | Subcarriers 3, 4, and |
| | | | 5 in the PRB m3 |
| 00110 | PRB n and PRB n + 1 | 10110 | Subcarriers 6, 7, and |
| | | | 8 in the PRB m3 |
| 00111 | PRB n + 2 and PRB | 10111 | Subcarriers 9, 10, and |
| | n + 3 | | 11 in the PRB m3 |
| 01000 | Subcarriers 0, 1, and | 11000 | Subcarriers 0, 1, 2, 3, |
| | 2 in the PRB m1 | | 4, and 5 in the PRB |
| | | | m3 |
| 01001 | Subcarriers 3, 4, and | 11001 | Subcarriers 6, 7, 8, 9, |
| | 5 in the PRB m1 | | 10, and 11 in the PRB |
| | | | m3 |
| 01010 | Subcarriers 6, 7, and | 11010 | Subcarriers 0, 1, and |
| | 8 in the PRB m1 | | 2 in the PRB m4 |
| 01011 | Subcarriers 9, 10, | 11011 | Subcarriers 3, 4, and |
| | and 11 in the PRB | | 5 in the PRB m4 |
| | m1 | | |
| 01100 | Subcarriers 0, 1, 2, 3, | 11100 | Subcarriers 6, 7, and |
| | 4, and 5 in the PRB | | 8 in the PRB m4 |
| | m1 | | |
| 01101 | Subcarriers 6, 7, 8, 9, | 11101 | Subcarriers 9, 10, and |
| | 10, and 11 in the | | 11 in the PRB m4 |
| | PRB m1 | | |
| 01110 | Subcarriers 0, 1, and | 11110 | Subcarriers 0, 1, 2, 3, |
| | 2 in the PRB m2 | | 4, and 5 in the PRB |
| | | | m4 |
| 01111 | Subcarriers 3, 4, and | 11111 | Subcarriers 6, 7, 8, 9, |
| | 5 in the PRB m2 | | 10, and 11 in the PRB |
| | | | m4 |

For example, a mapping relationship between the 32 bit states and a resource allocation may alternatively meet Table 6. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are any four resource blocks in the system bandwidth that are configured by using the higher layer signaling. Herein, n is an integer greater than or equal to 0; n, n+1, n+2, n+3, n+4, and n+5 represent indexes of PRBs; m1 to m4 are integers greater than or equal to 0; and m1, m2, m3, and m4 represent indexes of PRBs.

TABLE 6

| States | | | |
|---|---|---|---|
| indicated | | | |
| by five bits | Allocated resource | Index | Allocated resource |
| 00000 | Subcarriers 0, 1, and 2 in | 10000 | Subcarriers 0, 1, 2, 3, 4, |
| | the PRB m1 | | and 5 in the PRB m3 |
| 00001 | Subcarriers 3, 4, and 5 in | 10001 | Subcarriers 6, 7, 8, 9, 10, |
| | the PRB m1 | | and 11 in the PRB m3 |
| 00010 | Subcarriers 6, 7, and 8 in | 10010 | Subcarriers 0, 1, and 2 in |
| | the PRB m1 | | the PRB m4 |
| 00011 | Subcarriers 9, 10, and 11 | 10011 | Subcarriers 3, 4, and 5 in |
| | in the PRB m1 | | the PRB m4 |
| 00100 | Subcarriers 0, 1, 2, 3, 4, | 10100 | Subcarriers 6, 7, and 8 in |
| | and 5 in the PRB m1 | | the PRB m4 |
| 00101 | Subcarriers 6, 7, 8, 9, 10, | 10101 | Subcarriers 9, 10, and 11 |
| | and 11 in the PRB m1 | | in the PRB m4 |
| 00110 | Subcarriers 0, 1, and 2 in | 10110 | Subcarriers 0, 1, 2, 3, 4, |
| | the PRB m2 | | and 5 in the PRB m4 |
| 00111 | Subcarriers 3, 4, and 5 in | 10111 | Subcarriers 6, 7, 8, 9, 10, |
| | the PRB m2 | | and 11 in the PRB m4 |
| 01000 | Subcarriers 6, 7, and 8 in | 11000 | PRB n |
| | the PRB m2 | | |
| 01001 | Subcarriers 9, 10, and 11 | 11001 | PRB n + 1 |
| | in the PRB m2 | | |
| 01010 | Subcarriers 0, 1, 2, 3, 4, | 11010 | PRB n + 2 |
| | and 5 in the PRB m2 | | |
| 01011 | Subcarriers 6, 7, 8, 9, 10, | 11011 | PRB n + 3 |
| | and 11 in the PRB m2 | | |
| 01100 | Subcarriers 0, 1, and 2 in | 11100 | PRB n + 4 |
| | the PRB m3 | | |
| 01101 | Subcarriers 3, 4, and 5 in | 11101 | PRB n + 5 |
| | the PRB m3 | | |
| 01110 | Subcarriers 6, 7, and 8 in | 11110 | PRB n and PRB n + 1 |
| | the PRB m3 | | |
| 01111 | Subcarriers 9, 10, and 11 | 11111 | PRB n + 2 and PRB |
| | in the PRB m3 | | n + 3 |

For example, a mapping relationship between the 32 bit states and a resource allocation may alternatively meet Table 7. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are any four resource blocks in the system bandwidth that are configured by using the higher layer signaling. Herein, n is an integer greater than or equal to 0; n, n+1, n+2, n+3, n+4, and n+5 represent indexes of PRBs; m1 to m4 are integers greater than or equal to 0; and m1, m2, m3, and m4 represent indexes of PRBs.

TABLE 7

| States | | | |
|---|---|---|---|
| indicated | | | |
| by five bits | Allocated resource | Index | Allocated resource |
| 00000 | PRB n | 10000 | Subcarriers 0, 1, and |
| | | | 2 in the PRB m1 |
| 00001 | PRB n + 1 | 10001 | Subcariers 3, 4, and |
| | | | 5 in the PRB m1 |
| 00010 | PRB n + 2 | 10010 | Subcarriers 6, 7, and |
| | | | 8 in the PRB m1 |
| 00011 | PRB n + 3 | 10011 | Subcarriers 9, 10, and |
| | | | 11 in the PRB m1 |
| 00100 | PRB n + 4 | 10100 | Subcarriers 0, 1, and |
| | | | 2 in the PRB m2 |
| 00101 | PRB n + 5 | 10101 | Subcarriers 3, 4, and |
| | | | 5 in the PRB m2 |
| 00110 | PRB n and PRB n + 1 | 10110 | Subcarriers 6, 7, and |
| | | | 8 in the PRB m2 |
| 00111 | PRB n + 2 and PRB | 10111 | Subcarriers 9, 10, and |
| | n + 3 | | 11 in the PRB m2 |
| 01000 | Subcarriers 0, 1, 2, 3, | 11000 | Subcarriers 0, 1, and |
| | 4, and 5 in the PRB | | 2 in the PRB m3 |
| | m1 | | |
| 01001 | Subcarriers 6, 7, 8, 9, | 11001 | Subcarriers 3, 4, and |
| | 10, and 11 in the | | 5 in the PRB m3 |
| | PRB m1 | | |
| 01010 | Subcarriers 0, 1, 2, 3, | 11010 | Subcarriers 6, 7, and |
| | 4, and 5 in the PRB | | 8 in the PRB m3 |
| | m2 | | |
| 01011 | Subcarriers 6, 7, 8, 9, | 11011 | Subcarriers 9, 10, and |
| | 10, and 11 in the | | 11 in the PRB m3 |
| | PRB m2 | | |
| 01100 | Subcarriers 0, 1, 2, 3, | 11100 | Subcarriers 0, 1, and |
| | 4, and 5 in the PRB | | 2 in the PRB m4 |
| | m3 | | |
| 01101 | Subcarriers 6, 7, 8, 9, | 11101 | Subcarriers 3, 4, and |
| | 10, and 11 in the | | 5 in the PRB m4 |
| | PRB m3 | | |
| 01110 | Subcarriers 0, 1, 2, 3, | 11110 | Subcarriers 6, 7, and |
| | 4, and 5 in the PRB | | 8 in the PRB m4 |
| | m4 | | |
| 01111 | Subcarriers 6, 7, 8, 9, | 11111 | Subcarriers 9, 10, and |
| | 10, and 11 in the | | 11 in the PRB m4 |
| | PRB m4 | | |

For example, a mapping relationship between the 32 bit states and a resource allocation may alternatively meet Table 8. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are any four resource blocks in the system bandwidth that are configured by using the higher layer signaling. Herein, n is an integer greater than or equal to 0; n, n+1, n+2, n+3, n+4, and n+5 represent indexes of PRBs; m1 to m4 are integers greater than or equal to 0; and m1, m2, m3, and m4 represent indexes of PRBs.

TABLE 8

| States | | | |
|---|---|---|---|
| indicated | | | |
| by five bits | Allocated resource | Index | Allocated resource |
| 00000 | Subcarriers 0, 1, 2, 3, | 10000 | Subcarriers 0, 1, and |
| | 4, and 5 in the PRB | | 2 in the PRB m3 |
| | m1 | | |
| 00001 | Subcarriers 6, 7, 8, 9, | 10001 | Subcarriers 3, 4, and |
| | 10, and 11 in the | | 5 in the PRB m3 |
| | PRB m1 | | |
| 00010 | Subcarriers 0, 1, 2, 3, | 10010 | Subcarriers 6, 7, and |
| | 4, and 5 in the PRB | | 8 in the PRB m3 |
| | m2 | | |
| 00011 | Subcarriers 6, 7, 8, 9, | 10011 | Subcarriers 9, 10, |
| | 10, and 11 in the | | and 11 in the PRB |
| | PRB m2 | | m3 |
| 00100 | Subcarriers 0, 1, 2, 3, | 10100 | Subcarriers 0, 1, and |
| | 4, and 5 in the PRB | | 2 in the PRB m4 |
| | m3 | | |
| 00101 | Subcarriers 6, 7, 8, 9, | 10101 | Subcarriers 3, 4, and |
| | 10, and 11 in the | | 5 in the PRB m4 |
| | PRB m3 | | |
| 00110 | Subcarriers 0, 1, 2, 3, | 10110 | Subcarriers 6, 7, and |
| | 4, and 5 in the PRB | | 8 in the PRB m4 |
| | m4 | | |
| 00111 | Subcarriers 6, 7, 8, 9, | 10111 | Subcarriers 9, 10, |
| | 10, and 11 in the | | and 11 in the PRB |
| | PRB m4 | | m4 |
| 01000 | Subcarriers 0, 1, and | 11000 | PRB n |
| | 2 in the PRB m1 | | |
| 01001 | Subcarriers 3, 4, and | 11001 | PRB n + 1 |
| | 5 in the PRB m1 | | |
| 01010 | Subcarriers 6, 7, and | 11010 | PRB n + 2 |
| | 8 in the PRB m1 | | |
| 01011 | Subcarriers 9, 10, | 11011 | PRB n + 3 |
| | and 11 in the PRB | | |
| | m1 | | |
| 01100 | Subcarriers 0, 1, and | 11100 | PRB n + 4 |
| | 2 in the PRB m2 | | |
| 01101 | Subcarriers 3, 4, and | 11101 | PRB n + 5 |
| | 5 in the PRB m2 | | |
| 01110 | Subcarriers 6, 7, and | 11110 | PRB n and PRB n + 1 |
| | 8 in the PRB m2 | | |
| 01111 | Subcarriers 9, 10, | 11111 | PRB n + 2 and PRB |
| | and 11 in the PRB | | n + 3 |
| | m2 | | |

It should be noted that Table 5 to Table 8 are merely examples for description, the six types indicate resource allocation of one PRB in the narrowband, the two types indicate resource allocation of two PRBs in the narrowband, the eight types indicate resource allocation of six subcarriers in one of four PRBs configured by using the higher layer signaling, and the 16 types indicate resource allocation of three subcarriers in one of the four PRBs configured by using the higher layer signaling. The resource allocation may be alternatively indicated based on another mapping relationship.

In a third possible implementation, for a terminal device in a coverage enhancement mode B, an example in which the resource allocation information includes

$$⌈ {log}_{2} ⌊ \frac{{N}_{R B}^{U L}}{6} ⌋ ⌉ + 6$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes

$$⌈ {log}_{2} ⌊ \frac{{N}_{R B}^{U L}}{6} ⌋ ⌉$$

bits, the

$$⌈ {log}_{2} ⌊ \frac{{N}_{R B}^{U L}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes six bits, and the six bits have 64 bit states, where the 64 bit states include six bit states, and each of the six bit states indicates that one resource block in the narrowband is allocated to user equipment; and/or the 64 bit states further include two bit states, and each of the two bit states indicates that two resource blocks in the narrowband are allocated to the user equipment; and/or the 64 bit states further include 12 bit states, each of the 12 bit states indicates that six subcarriers in a physical resource block k are allocated to the user equipment, and the physical resource block k is a resource block in the narrowband; and/or the 64 bit states further include 24 bit states, each of the 24 bit states indicates that three subcarriers in a physical resource block p are allocated to the user equipment, and the physical resource block p is a resource block in the narrowband.

For example, a mapping relationship between the 32 bit states and a resource allocation may alternatively meet Table 9. A PRB n, a PRB n+1, a PRB n+2, a PRB n+3, a PRB n+4, and a PRB n+5 are six consecutive PRBs in the narrowband. Herein, n is an integer greater than or equal to 0; and n, n+1, n+2, n+3, n+4, and n+5 represent indexes of PRBs.

TABLE 9

| States | | | |
|---|---|---|---|
| indicated | | | |
| by five bits | Allocated resource | Index | Allocated resource |
| 000000 | PRB n | 010110 | Subcarriers 6, 7, and 8 in |
| | | | the PRB n + 2 |
| 000001 | PRB n + 1 | 010111 | Subcarriers 9, 10, and 11 |
| | | | in the PRB n + 2 |
| 000010 | PRB n + 2 | 011000 | Subcarriers 0, 1, 2, 3, 4, |
| | | | and 5 in the PRB n + 2 |
| 000011 | PRB n + 3 | 011001 | Subcarriers 6, 7, 8, 9, 10, |
| | | | and 11 in the PRB n + 2 |
| 000100 | PRB n + 4 | 011010 | Subcarriers 0, 1, and 2 in |
| | | | the PRB n + 3 |
| 000101 | PRB n + 5 | 011011 | Subcarriers 3, 4, and 5 in |
| | | | the PRB n + 3 |
| 000110 | PRB n and PRB n + 1 | 011100 | Subcarriers 6, 7, and 8 in |
| | | | the PRB n + 3 |
| 000111 | PRB n + 2 and PRB n + 3 | 011101 | Subcarriers 9, 10, and 11 |
| | | | in the PRB n + 3 |
| 001000 | Subcarriers 0, 1, and 2 in | 011110 | Subcarriers 0, 1, 2, 3, 4, |
| | the PRB in | | and 5 in the PRB n + 3 |
| 001001 | Subcarriers 3, 4, and 5 in | 011111 | Subcarriers 6, 7, 8, 9, 10, |
| | the PRB n | | and 11 in the PRB n + 3 |
| 001010 | Subcarriers 6, 7, and 8 in | 100000 | Subcarriers 0, 1, and 2 in |
| | the PRB n | | the PRB n + 4 |
| 001011 | Subcarriers 9, 10, and 11 | 100001 | Subcarriers 3, 4, and 5 in |
| | in the PRB n | | the PRB n + 4 |
| 001100 | Subcarriers 0, 1, 2, 3, 4, | 100010 | Subcarriers 6, 7, and 8 in |
| | and 5 in the PRB n | | the PRB n + 4 |
| 001101 | Subcarriers 6, 7, 8, 9, 10, | 100011 | Subcarriers 9, 10, and 11 |
| | and 11 in the PRB n | | in the PRB n + 4 |
| 001110 | Subcarriers 0, 1, and 2 in | 100100 | Subcarriers 0, 1, 2, 3, 4, |
| | the PRB n + 1 | | and 5 in the PRB n + 4 |
| 001111 | Subcarriers 3, 4, and 5 in | 100101 | Subcarriers 6, 7, 8, 9, 10, |
| | the PRB n + 1 | | and 11 in the PRB n + 4 |
| 010000 | Subcarriers 6, 7, and 8 in | 100110 | Subcarriers 0, 1, and 2 in |
| | the PRB n + 1 | | the PRB n + 5 |
| 010001 | Subcarriers 9, 10, and 11 | 100111 | Subcarriers 3, 4, and 5 in |
| | in the PRB n + 1 | | the PRB n + 5 |
| 010010 | Subcarriers 0, 1, 2, 3, 4, | 101000 | Subcarriers 6, 7, and 8 in |
| | and 5 in the PRB n + 1 | | the PRB n + 5 |
| 010011 | Subcarriers 6, 7, 8, 9, 10, | 101001 | Subcarriers 9, 10, and 11 |
| | and 11 in the PRB n + 1 | | in the PRB n + 5 |
| 010100 | Subcarriers 0, 1, and 2 in | 101010 | Subcarriers 0, 1, 2, 3, 4, |
| | the PRB n + 2 | | and 5 in the PRB n + 5 |
| 010101 | Subcarriers 3, 4, and 5 in | 101011 | Subcarriers 6, 7, 8, 9, 10, |
| | the PRB n + 2 | | and 11 in the PRB n + 5 |

For example, a mapping relationship between the 32 bit states and a resource allocation may alternatively meet Table 10. A PRB n, a PRB n+1, a PRB n+2, a PRB n+3, a PRB n+4, and a PRB n+5 are six consecutive PRBs in the narrowband. Herein, n is an integer greater than or equal to 0; and n, n+1, n+2, n+3, n+4, and n+5 represent indexes of PRBs.

TABLE 10

| States | | | |
|---|---|---|---|
| indicated | | | |
| by five bits | Allocated resource | Index | Allocated resource |
| 000000 | Subcarriers 0, 1, and 2 in | 010110 | Subcarriers 0, 1, 2, 3, 4, |
| | the PRB n | | and 5 in the PRB n + 3 |
| 000001 | Subcarriers 3, 4, and 5 in | 010111 | Subcarriers 6, 7, 8, 9, 10, |
| | the PRB n | | and 11 in the PRB n + 3 |
| 000010 | Subcarriers 6, 7, and 8 in | 011000 | Subcarriers 0, 1, and 2 in |
| | the PRB n | | the PRB n + 4 |
| 000011 | Subcarriers 9, 10, and 11 | 011001 | Subcarriers 3, 4, and 5 in |
| | the PRB n | | the PRB n + 4 |
| 000100 | Subcarriers 0, 1, 2, 3, 4, | 011010 | Subcarriers 6, 7, and 8 in |
| | and 5 in the PRB n | | the PRB n + 4 |
| 000101 | Subcarriers 6, 7, 8, 9, 10, | 011011 | Subcarriers 9, 10, and 11 |
| | and 11 in the PRB n | | in the PRB n + 4 |
| 000110 | Subcarriers 0, 1, and 2 in | 011100 | Subcarriers 0, 1, 2, 3, 4, |
| | the PRB n + 1 | | and 5 in the PRB n + 4 |
| 000111 | Subcarriers 3, 4, and 5 in | 011101 | Subcarriers 6, 7, 8, 9, 10, |
| | the PRB n + 1 | | and 11 in the PRB n + 4 |
| 001000 | Subcarriers 6, 7, and 8 in | 011110 | Subcarriers 0, 1, and 2 in |
| | the PRB n + 1 | | the PRB n + 5 |
| 001001 | Subcarriers 9, 10, and 11 | 011111 | Subcarriers 3, 4, and 5 in |
| | in the PRB n + 1 | | the PRB n + 5 |
| 001010 | Subcarriers 0, 1, 2, 3, 4, | 100000 | Subcarriers 6, 7, and 8 in |
| | and 5 in the PRB n + 1 | | the PRB n + 5 |
| 001011 | Subcarriers 6, 7, 8, 9, 10, | 100001 | Subcarriers 9, 10, and 11 |
| | and 11 in the PRB n + 1 | | in the PRB n + 5 |
| 001100 | Subcarriers 0, 1, and 2 in | 100010 | Subcarriers 0, 1, 2, 3, 4, |
| | the PRB n + 2 | | and 5 in the PRB n + 5 |
| 001101 | Subcarriers 3, 4, and 5 in | 100011 | Subcarriers 6, 7, 8, 9, 10, |
| | the PRB n + 2 | | and 11 in the PRB n + 5 |
| 001110 | Subcarriers 6, 7, and 8 in | 100100 | PRB n |
| | the PRB n + 2 | | |
| 001111 | Subcarriers 9, 10, and 11 | 100101 | PRB n + 1 |
| | in the PRB n + 2 | | |
| 010000 | Subcarriers 0, 1, 2, 3, 4, | 100110 | PRB n + 2 |
| | and 5 in the PRB n + 2 | | |
| 010001 | Subcarriers 6, 7, 8, 9, 10, | 100111 | PRB n + 3 |
| | and 11 in the PRB n + 2 | | |
| 010010 | Subcarriers 0, 1, and 2 in | 101000 | PRB n + 4 |
| | the PRB n + 3 | | |
| 010011 | Subcarriers 3, 4, and 5 in | 101001 | PRB n + 5 |
| | the PRB n + 3 | | |
| 010100 | Subcarriers 6, 7, and 8 in | 101010 | PRB n and PRB n + 1 |
| | the PRB n + 3 | | |
| 010101 | Subcarriers 9, 10, and 11 | 101011 | PRB n + 2 and PRB |
| | in the PRB n + 3 | | n + 3 |

For example, a mapping relationship between the 32 bit states and a resource allocation may alternatively meet Table 11. A PRB n, a PRB n+1, a PRB n+2, a PRB n+3, a PRB n+4, and a PRB n+5 are six consecutive PRBs in the narrowband. Herein, n is an integer greater than or equal to 0; and n, n+1, n+2, n+3, n+4, and n+5 represent indexes of PRBs.

TABLE 11

| States | | | |
|---|---|---|---|
| indicated | | | |
| by five bits | Allocated resource | Index | Allocated resource |
| 000000 | PRB n | 010110 | Subcarriers 6, 7, and 8 in |
| | | | the PRB n |
| 000001 | PRB n + 1 | 010111 | Subcarriers 9, 10, and 11 |
| | | | in the PRB n |
| 000010 | PRB n + 2 | 011000 | Subcarriers 0, 1, 2 in |
| | | | the PRB n + 1 |
| 000011 | PRB n + 3 | 011001 | Subcarriers 3, 4, and 5 in |
| | | | the PRB n + 1 |
| 000100 | PRB n + 4 | 011010 | Subcarriers 6, 7, and 8 in |
| | | | the PRB n + 1 |
| 000101 | PRB n + 5 | 011011 | Subcarriers 9, 10, and 11 |
| | | | in the PRB n + 1 |
| 000110 | PRB n and PRB n + 1 | 011100 | Subcarriers 0, 1, and 2 in |
| | | | the PRB n + 2 |
| 000111 | PRB n + 2 and PRB n + 3 | 011101 | Subcarriers 3, 4, and 5 in |
| | | | the PRB n + 2 |
| 001000 | Subcarriers 0, 1, 2, 3, 4, | 011110 | Subcarriers 6, 7, and 8 in |
| | and 5 in the PRB n | | the PRB n + 2 |
| 001001 | Subcarriers 6, 7, 8, 9, 10, | 011111 | Subcarriers 9, 10, and 11 |
| | and 11 in the PRB n | | in the PRB n + 2 |
| 001010 | Subcarriers 0, 1, 2, 3, 4, | 100000 | Subcarriers 0, 1, and 2 in |
| | and 5 in the PRB n + 1 | | the PRB n + 3 |
| 001011 | Subcarriers 6, 7, 8, 9, 10, | 100001 | Subcarriers 3, 4, and 5 in |
| | and 11 in the PRB n + 1 | | the PRB n + 3 |
| 001100 | Subcarriers 0, 1, 2, 3, 4, | 100010 | Subcarriers 6, 7, and 8 in |
| | and 5 in the PRB n + 2 | | the PRB n + 3 |
| 001101 | Subcarriers 6, 7, 8, 9, 10, | 100011 | Subcarriers 9, 10, and 11 |
| | and 11 in the PRB n + 2 | | in the PRB n + 3 |
| 001110 | Subcarriers 0, 1, 2, 3, 4, | 100100 | Subcarriers 0, 1, and 2 in |
| | and 5 in the PRB n + 3 | | the PRB n + 4 |
| 001111 | Subcarriers 6, 7, 8, 9, 10, | 100101 | Subcarriers 3, 4, and 5 in |
| | and 11 in the PRB n + 3 | | the PRB n + 4 |
| 010000 | Subcarriers 0, 1, 2, 3, 4, | 100110 | Subcarriers 6, 7, and 8 in |
| | and 5 in the PRB n + 4 | | the PRB n + 4 |
| 010001 | Subcarriers 6, 7, 8, 9, 10, | 100111 | Subcarriers 9, 10, and 11 |
| | and 11 in the PRB n + 4 | | in the PRB n + 4 |
| 010010 | Subcarriers 0, 1, 2, 3, 4, | 101000 | Subcarriers 0, 1, and 2 in |
| | and 5 in the PRB n + 5 | | the PRB n + 5 |
| 010011 | Subcarriers 6, 7, 8, 9, 10, | 101001 | Subcarriers 3, 4, and 5 in |
| | and 11 in the PRB n + 5 | | the PRB n + 5 |
| 010100 | Subcarriers 0, 1, and 2 in | 101010 | Subcarriers 6, 7, and 8 in |
| | the PRB n | | the PRB n + 5 |
| 010101 | Subcarriers 3, 4, and 5 in | 101011 | Subcarriers 9, 10, and 11 |
| | the PRB n | | in the PRB n + 5 |

For example, a mapping relationship between the 32 bit states and a resource allocation may alternatively meet Table 12. For example, a mapping relationship between the 32 bit states and a resource allocation may alternatively meet Table 11. A PRB n, a PRB n+1, a PRB n+2, a PRB n+3, a PRB n+4, and a PRB n+5 are six consecutive PRBs in the narrowband. Herein, n is an integer greater than or equal to 0; and n, n+1, n+2, n+3, n+4, and n+5 represent indexes of PRBs.

TABLE 12

| States | | | |
|---|---|---|---|
| indicated | | | |
| by five | | | |
| bits | Allocated resource | Index | Allocated resource |
| 000000 | Subcarriers 0, 1, 2, 3, 4, | 010110 | Subcarriers 6, 7, and 8 in |
| | and 5 in the PRB n | | the PRB n + 2 |
| 000001 | Subcarriers 6, 7, 8, 9, 10, | 010111 | Subcarriers 9, 10, and 11 |
| | and 11 in the PRB n | | in the PRB n + 2 |
| 000010 | Subcarriers 0, 1, 2, 3, 4, | 011000 | Subcarriers 0, 1, and 2 in |
| | and 5 in the PRB n + 1 | | the PRB n + 3 |
| 000011 | Subcarriers 6, 7, 8, 9, 10, | 011001 | Subcarriers 3, 4, and 5 in |
| | and 11 in the PRB n + 1 | | the PRB n + 3 |
| 000100 | Subcarriers 0, 1, 2, 3, 4, | 011010 | Subcarriers 6, 7, and 8 in |
| | and 5 in the PRB n + 2 | | the PRB n + 3 |
| 000101 | Subcarriers 6, 7, 8, 9, 10, | 011011 | Subcarriers 9, 10, and 11 |
| | and 11 in the PRB n + 2 | | in the PRB n + 3 |
| 000110 | Subcarriers 0, 1, 2, 3, 4, | 011100 | Subcarriers 0, 1, and 2 in |
| | and 5 in the PRB n + 3 | | the PRB n + 4 |
| 000111 | Subcarriers 6, 7, 8, 9, 10, | 011101 | Subcarriers 3, 4, and 5 in |
| | and 11 in the PRB n + 3 | | the PRB n + 4 |
| 001000 | Subcarriers 0, 1, 2, 3, 4, | 011110 | Subcarriers 6, 7, and 8 in |
| | and 5 in the PRB n + 4 | | the PRB n + 4 |
| 001001 | Subcarriers 6, 7, 8, 9, 10, | 011111 | Subcarriers 9, 10, and 11 |
| | and 11 in the PRB n + 4 | | in the PRB n + 4 |
| 001010 | Subcarriers 0, 1, 2, 3, 4, | 100000 | Subcarriers 0, 1, and 2 in |
| | and 5 in the PRB n + 5 | | the PRB n + 5 |
| 001011 | Subcarriers 6, 7, 8, 9, 10, | 100001 | Subcarriers 3, 4, and 5 in |
| | and 11 in the PRB n + 5 | | the PRB n + 5 |
| 001100 | Subcarriers 0, 1, and 2 in | 100010 | Subcarriers 6, 7, and 8 in |
| | the PRB n | | the PRB n + 5 |
| 001101 | Subcarriers 3, 4, and 5 in | 100011 | Subcarriers 9, 10, and 11 |
| | the PRB n | | in the PRB n + 5 |
| 001110 | Subcarriers 6, 7, and 8 in | 100100 | PRB n |
| | the PRB n | | |
| 001111 | Subcarriers 9, 10, and 11 | 100101 | PRB n + 1 |
| | in the PRB n | | |
| 010000 | Subcarriers 0,1, and 2 in | 100110 | PRB n + 2 |
| | the PRB n + 1 | | |
| 010001 | Subcarriers 3,4, and 5 in | 100111 | PRB n + 3 |
| | the PRB n + 1 | | |
| 010010 | Subcarriers 6, 7, and 8 in | 101000 | PRB n + 4 |
| | the PRB n + 1 | | |
| 010011 | Subcarriers 9, 10, and 11 | 101001 | PRB n + 5 |
| | in the PRB n + 1 | | |
| 010100 | Subcarriers 0, 1, and 2 in | 101010 | PRB n and PRB n + 1 |
| | the PRB n + 2 | | |
| 010101 | Subcarriers 3, 4, and 5 in | 101011 | PRB n + 2 and |
| | the PRB n + 2 | | PRB n + 3 |

It should be noted that Table 9 to Table 12 are merely examples for description, the six types indicate resource allocation of one PRB in the narrowband, the two types indicate resource allocation of two PRBs in the narrowband, the eight types indicate resource allocation of six subcarriers in one of four PRBs configured by using the higher layer signaling, and the 16 types indicate resource allocation of three subcarriers in one of the four PRBs configured by using the higher layer signaling. The resource allocation may be alternatively indicated based on another mapping relationship.

In a fourth possible implementation, for a terminal device in a coverage enhancement mode B, an example in which the resource allocation information includes

$$⌈ {log}_{2} ⌊ \frac{{N}_{R B}^{U L}}{6} ⌋ ⌉ + 6$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information further includes six bits, and the six bits have 64 bit states, where the 64 bit states include six bit states, the resource allocation information further includes

$$⌈ {log}_{2} ⌊ \frac{{N}_{R B}^{U L}}{6} ⌋ ⌉$$

bits, the

$$⌈ {log}_{2} ⌊ \frac{{N}_{R B}^{U L}}{6} ⌋ ⌉$$

bits indicate a narrowband, and each of the six bit states indicates that one resource block in the narrowband is allocated to user equipment; and/or the 64 bit states further include two bit states, the resource allocation information further includes

$$⌈ {log}_{2} ⌊ \frac{{N}_{R B}^{U L}}{6} ⌋ ⌉$$

bits, the

$$⌈ {log}_{2} ⌊ \frac{{N}_{R B}^{U L}}{6} ⌋ ⌉$$

bits indicate a narrowband, and each of the two bit states indicates that two resource blocks in the narrowband are allocated to the user equipment; and/or the 64 bit states further include 12 bit states, each of the 12 bit states indicates that six subcarriers in a physical resource block k are allocated to the user equipment, the physical resource block k is one of six physical resource blocks configured by using higher layer signaling, the resource allocation information further includes

$$⌈ {log}_{2} ⌊ \frac{{N}_{R B}^{U L}}{6} ⌋ ⌉$$

bits, and states of the

$$⌈ {log}_{2} ⌊ \frac{{N}_{R B}^{U L}}{6} ⌋ ⌉$$

bits are set to all ones or all zeros; and/or the 32 bit states further include 24 bit states, each of the 24 bit states indicates that three subcarriers in a physical resource block y are allocated to the user equipment, the physical resource block y is one of the six physical resource blocks configured by using the higher layer signaling, the resource allocation information further includes

$$⌈ {log}_{2} ⌊ \frac{{N}_{R B}^{U L}}{6} ⌋ ⌉$$

bits, and states of the

$$⌈ {log}_{2} ⌊ \frac{{N}_{R B}^{U L}}{6} ⌋ ⌉$$

bits are set to all ones or all zeros. Herein, N_{RB}^{UL} represents a quantity of uplink RBs corresponding to a system bandwidth, ┌ ┐ represents rounding up, and └ ┘ represents rounding down.

Optionally, the six physical resource blocks configured by using the higher layer signaling are any six physical resource blocks configured in the system bandwidth.

For example, a mapping relationship between the 32 bit states and a resource allocation may alternatively meet Table 13. A PRB n, a PRB n+1, a PRB n+2, a PRB n+3, a PRB n+4, and a PRB n+5 are six consecutive PRBs in the narrowband. A PRB m1, a PRB m2, a PRB m3, a PRB m4, a PRB m5, and a PRB m6 are any six physical resource blocks in the system bandwidth that are configured by using the higher layer signaling. Herein, n is an integer greater than or equal to 0; n, n+1, n+2, n+3, n+4, and n+5 represent indexes of PRBs; m1 to m6 are integers greater than or equal to 0; and m1, m2, m3, m4, m5, and m6 represent indexes of PRBs.

TABLE 13

| States | | States | |
|---|---|---|---|
| indicated | | indicated | |
| by six | | by six | |
| bits | Allocated resource | bits | Allocated resource |
| 000000 | PRB n | 010110 | Subcarriers 6, 7, and |
| | | | 8 in the PRB n + 2 |
| 000001 | PRB n + 1 | 010111 | Subcarriers 9, 10, and |
| | | | 11 in the PRB m3 |
| 000010 | PRB n + 2 | 011000 | Subcarriers 0, 1, 2, 3, |
| | | | 4, and 5 in the PRB |
| | | | m3 |
| 000011 | PRB n + 3 | 011001 | Subcarriers 6, 7, 8, 9, |
| | | | 10, and 11 in the PRB |
| | | | m3 |
| 000100 | PRB n + 4 | 011010 | Subcarriers 0, 1, and |
| | | | 2 in the PRB m4 |
| 000101 | PRB n + 5 | 011011 | Subcarriers 3, 4, and |
| | | | 5 in the PRB m4 |
| 000110 | PRB n and PRB n + 1 | 011100 | Subcarriers 6, 7, and |
| | | | 8 in the PRB m4 |
| 000111 | PRB n + 2 and PRB | 011101 | Subcarriers 9, 10, and |
| | n + 3 | | 11 in the PRB m4 |
| 001000 | Subcarriers 0, 1, and | 011110 | Subcarriers 0, 1, 2, 3, |
| | 2 in the PRB m1 | | 4, and 5 in the PRB |
| | | | m4 |
| 001001 | Subcarriers 3,4, and | 011111 | Subcarriers 6, 7, 8, 9, |
| | 5 in the PRB m1 | | 10, and 11 in the PRB |
| | | | m4 |
| 001010 | Subcarriers 6, 7, and | 100000 | Subcarriers 0, 1, and |
| | 8 in the PRB m1 | | 2 in the PRB m5 |
| 001011 | Subcarriers 9, 10, and | 100001 | Subcarriers 3, 4, and |
| | 11 in the PRB m1 | | 5 in the PRB m5 |
| 001100 | Subcarriers 0, 1, 2, 3, | 100010 | Subcarriers 6, 7, and |
| | 4, and 5 in the PRB | | 8 in the PRB m5 |
| | m1 | | |
| 001101 | Subcarriers 6, 7, 8, 9, | 100011 | Subcarriers 9, 10, and |
| | 10, and 11 in the | | 11 in the PRB m5 |
| | PRB m1 | | |
| 001110 | Subcarriers 0, 1, and | 100100 | Subcarriers 0, 1, 2, 3, |
| | 2 in the PRB m2 | | 4, and 5 in the PRB |
| | | | m5 |
| 001111 | Subcarriers 3, 4, and | 100101 | Subcarriers 6, 7, 8, 9, |
| | 5 in the PRB m2 | | 10, and 11 in the PRB |
| | | | m5 |
| 010000 | Subcarriers 6, 7, and | 100110 | Subcarriers 0, 1, and |
| | 8 in the PRB m2 | | 2 in the PRB m6 |
| 010001 | Subcarriers 9, 10, and | 100111 | Subcarriers 3, 4, and |
| | 11 in the PRB m2 | | 5 in the PRB m6 |
| 010010 | Subcarriers 0, 1, 2, 3, | 101000 | Subcarriers 6, 7, and |
| | 4, and 5 in the PRB | | 8 in the PRB m6 |
| | m2 | | |
| 010011 | Subcarriers 6, 7, 8, 9, | 101001 | Subcarriers 9, 10, and |
| | 10, and 11 in the | | 11 in the PRB m6 |
| | PRB m2 | | |
| 010100 | Subcarriers 0, 1, and | 101010 | Subcarriers 0, 1, 2, 3, |
| | 2 in the PRB m3 | | 4, and 5 in the PRB |
| | | | m6 |
| 010101 | Subcarriers 3, 4, and | 101011 | Subcarriers 6, 7, 8, 9, |
| | Sin the PRB m3 | | 10, and 11 in the PRB |
| | | | m6 |

For example, a mapping relationship between the 32 bit states and a resource allocation may alternatively meet Table 14. A PRB n, a PRB n+1, a PRB n+2, a PRB n+3, a PRB n+4, and a PRB n+5 are six consecutive PRBs in the narrowband. A PRB m1, a PRB m2, a PRB m3, a PRB m4, a PRB m5, and a PRB m6 are any six physical resource blocks in the system bandwidth that are configured by using the higher layer signaling. Herein, n is an integer greater than or equal to 0; n, n+1, n+2, n+3, n+4, and n+5 represent indexes of PRBs; m1 to m6 are integers greater than or equal to 0; and m1, m2, m3, m4, m5, and m6 represent indexes of PRBs.

TABLE 14

| States | | States | |
|---|---|---|---|
| indicated | | indicated | |
| by six | | by six | |
| bits | Allocated resource | bits | Allocated resource |
| 000000 | Subcarriers 0, 1, and | 010110 | Subcarriers 0, 1, 2, 3, |
| | 2 in the PRB m1 | | 4, and 5 in the PRB |
| | | | m4 |
| 000001 | Subcarriers 3, 4, and | 010111 | Subcarriers 6, 7, 8, 9, |
| | 5 in the PRB m1 | | 10, and 11 in the PRB |
| | | | m4 |
| 000010 | Subcarriers 6, 7, and | 011000 | Subcarriers 0, 1, and |
| | 8 in the PRB m1 | | 2 in the PRB m5 |
| 000011 | Subcarriers 9, 10, | 011001 | Subcarriers 3, 4, and |
| | and 11 in the PRB | | 5 in the PRB m5 |
| | m1 | | |
| 000100 | Subcarriers 0, 1, 2, 3, | 011010 | Subcarriers 6, 7, and |
| | 4, and 5 in the PRB | | 8 in the PRB m5 |
| | m1 | | |
| 000101 | Subcarriers 6, 7, 8, 9, | 011011 | Subcarriers 9, 10, and |
| | 10, and 11 in the | | 11 in the PRB m5 |
| | PRB m1 | | |
| 000110 | Subcarriers 0, 1, and | 011100 | Subcarriers 0, 1, 2, 3, |
| | 2 in the PRB m2 | | 4, and 5 in the PRB |
| | | | m5 |
| 000111 | Subcarriers 3, 4, and | 011101 | Subcarriers 6, 7, 8, 9, |
| | 5 in the PRB m2 | | 10, and 11 in the PRB |
| | | | m5 |
| 001000 | Subcarriers 6, 7, and | 011110 | Subcarriers 0, 1, and |
| | 8 in the PRB m2 | | 2 in the PRB m6 |
| 001001 | Subcarriers 9, 10, | 011111 | Subcarriers 3, 4, and |
| | and 11 in the PRB | | 5 in the PRB m6 |
| | m2 | | |
| 001010 | Subcarriers 0, 1, 2, 3, | 100000 | Subcarriers 6, 7, and |
| | 4, and 5 in the PRB | | 8 in the PRB m6 |
| | m2 | | |
| 001011 | Subcarriers 6, 7, 8, 9, | 100001 | Subcarriers 9, 10, and |
| | 10, and 11 in the | | 11 in the PRB m6 |
| | PRB m2 | | |
| 001100 | Subcarriers 0, 1, and | 100010 | Subcarriers 0, 1, 2, 3, |
| | 2 in the PRB m3 | | 4, and 5 in the PRB |
| | | | m6 |
| 001101 | Subcarriers 3, 4, and | 100011 | Subcarriers 6, 7, 8, 9, |
| | 5 in the PRB m3 | | 10, and 11 in the PRB |
| | | | m6 |
| 001110 | Subcarriers 6, 7, and | 100100 | PRB n |
| | 8 in the PRB m3 | | |
| 001111 | Subcarriers 9, 10, | 100101 | PRB n + 1 |
| | and 11 in the PRB | | |
| | m3 | | |
| 010000 | Subcarriers 0, 1, 2, 3, | 100110 | PRB n + 2 |
| | 4, and 5 in the PRB | | |
| | m3 | | |
| 010001 | Subcarriers 6, 7, 8, 9, | 100111 | PRB n + 3 |
| | 10, and 11 in the | | |
| | PRB m3 | | |
| 010010 | Subcarriers 0, 1, and | 101000 | PRB n + 4 |
| | 2 in the PRB m4 | | |
| 010011 | Subcarriers 3, 4, and | 101001 | PRB n + 5 |
| | 5 in the PRB m4 | | |
| 010100 | Subcarriers 6, 7, and | 101010 | PRB n and PRB n + 1 |
| | 8 in the PRB m4 | | |
| 010101 | Subcarriers 9, 10, | 101011 | PRB n + 2 and PRB |
| | and 11 in the PRB | | n + 3 |
| | m4 | | |

For example, a mapping relationship between the 32 bit states and a resource allocation may alternatively meet Table 15. A PRB n, a PRB n+1, a PRB n+2, a PRB n+3, a PRB n+4, and a PRB n+5 are six consecutive PRBs in the narrowband. A PRB m1, a PRB m2, a PRB m3, a PRB m4, a PRB m5, and a PRB m6 are any six physical resource blocks in the system bandwidth that are configured by using the higher layer signaling. Herein, n is an integer greater than or equal to 0; n, n+1, n+2, n+3, n+4, and n+5 represent indexes of PRBs; m1 to m6 are integers greater than or equal to 0; and m1, m2, m3, m4, m5, and m6 represent indexes of PRBs.

TABLE 15

| States | | States | |
|---|---|---|---|
| indicated | | indicated | |
| by six | | by six | |
| bits | Allocated resource | bits | Allocated resource |
| 000000 | PRB n | 010110 | Subcarriers 6, 7, and |
| | | | 8 in the PRB m1 |
| 000001 | PRB n + 1 | 010111 | Subcarriers 9, 10, and |
| | | | 11 in the PRB m1 |
| 000010 | PRB n + 2 | 011000 | Subcarriers 0, 1, and |
| | | | 2 in the PRB m2 |
| 000011 | PRB n + 3 | 011001 | Subcarriers 3, 4, and |
| | | | 5 in the PRB m2 |
| 000100 | PRB n + 4 | 011010 | Subcarriers 6, 7, and |
| | | | 8 in the PRB m2 |
| 000101 | PRB n + 5 | 011011 | Subcarriers 9, 10, and |
| | | | 11 in the PRB m2 |
| 000110 | PRB n and PRB n + 1 | 011100 | Subcarriers 0, 1, and |
| | | | 2 in the PRB m3 |
| 000111 | PRB n + 2 and PRB | 011101 | Subcarriers 3, 4, and |
| | n + 3 | | 5 in the PRB m3 |
| 001000 | Subcarriers 0, 1, 2, 3, | 011110 | Subcarriers 6, 7, and |
| | 4, and 5 in the PRB | | 8 in the PRB m3 |
| | m1 | | |
| 001001 | Subcarriers 6, 7, 8, 9, | 011111 | Subcarriers 9, 10, and |
| | 10, and 11 in the | | 11 in the PRB m3 |
| | PRB m1 | | |
| 001010 | Subcarriers 0, 1, 2, 3, | 100000 | Subcarriers 0, 1, and |
| | 4, and 5 in the PRB | | 2 in the PRB m4 |
| | m2 | | |
| 001011 | Subcarriers 6, 7, 8, 9, | 100001 | Subcarriers 3, 4, and |
| | 10, and 11 in the | | 5 in the PRB m4 |
| | PRB m2 | | |
| 001100 | Subcarriers 0, 1, 2, 3, | 100010 | Subcarriers 6, 7, and |
| | 4, and 5 in the PRB | | 8 in the PRB m4 |
| | m3 | | |
| 001101 | Subcarriers 6, 7, 8, 9, | 100011 | Subcarriers 9, 10, and |
| | 10, and 11 in the | | 11 in the PRB m4 |
| | PRB m3 | | |
| 001110 | Subcarriers 0, 1, 2, 3, | 100100 | Subcarriers 0, 1, and |
| | 4, and 5 in the PRB | | 2 in the PRB m5 |
| | m4 | | |
| 001111 | Subcarriers 6, 7, 8, 9, | 100101 | Subcarriers 3,4, and |
| | 10, and 11 in the | | 5 in the PRB m5 |
| | PRB m4 | | |
| 010000 | Subcarriers 0, 1, 2, 3, | 100110 | Subcarriers 6, 7, and |
| | 4, and 5 in the PRB | | 8 in the PRB m5 |
| | m5 | | |
| 010001 | Subcarriers 6, 7, 8, 9, | 100111 | Subcarriers 9, 10, and |
| | 10, and 11 in the | | 11 in the PRB m5 |
| | PRB m5 | | |
| 010010 | Subcarriers 0, 1, 2, 3, | 101000 | Subcarriers 0, 1, and |
| | 4, and 5 in the PRB | | 2 in the PRB m6 |
| | m6 | | |
| 010011 | Subcarriers 6, 7, 8, 9, | 101001 | Subcarriers 3,4, and |
| | 10, and 11 in the | | 5 in the PRB m6 |
| | PRB m6 | | |
| 010100 | Subcarriers 0, 1, and | 101010 | Subcarriers 6, 7, and |
| | 2 in the PRB m1 | | 8 in the PRB m6 |
| 010101 | Subcarriers 3, 4, and | 101011 | Subcarriers 9, 10, and |
| | 5 in the PRB m1 | | 11 in the PRB m6 |

For example, a mapping relationship between the 32 bit states and a resource allocation may alternatively meet Table 16. A PRB n, a PRB n+1, a PRB n+2, a PRB n+3, a PRB n+4, and a PRB n+5 are six consecutive PRBs in the narrowband. A PRB m1, a PRB m2, a PRB m3, a PRB m4, a PRB m5, and a PRB m6 are any six physical resource blocks in the system bandwidth that are configured by using the higher layer signaling. Herein, n is an integer greater than or equal to 0; n, n+1, n+2, n+3, n+4, and n+5 represent indexes of PRBs; m1 to m6 are integers greater than or equal to 0; and m1, m2, m3, m4, m5, and m6 represent indexes of PRBs.

TABLE 16

| States | | States | |
|---|---|---|---|
| indicated | | indicated | |
| by six | | by six | |
| bits | Allocated resource | bits | Allocated resource |
| 000000 | Subcarriers 0, 1, 2, 3, | 010110 | Subcarriers 6, 7, and |
| | 4, and 5 in the PRB | | 8 in the PRB m3 |
| | m1 | | |
| 000001 | Subcarriers 6, 7, 8, 9, | 010111 | Subcarriers 9, 10, and |
| | 10, and 11 in the | | 11 in the PRB m3 |
| | PRB m1 | | |
| 000010 | Subcarriers 0, 1, 2, 3, | 011000 | Subcarriers 0, 1, and |
| | 4, and 5 in the PRB | | 2 in the PRB m4 |
| | m2 | | |
| 000011 | Subcarriers 6, 7, 8, 9, | 011001 | Subcarriers 3, 4, and |
| | 10, and 11 in the | | 5 in the PRB m4 |
| | PRB m2 | | |
| 000100 | Subcarriers 0, 1, 2, 3, | 011010 | Subcarriers 6, 7, and |
| | 4, and 5 in the PRB | | 8 in the PRB m4 |
| | m3 | | |
| 000101 | Subcarriers 6, 7, 8, 9, | 011011 | Subcarriers 9, 10, and |
| | 10, and 11 in the | | 11 in the PRB m4 |
| | PRB m3 | | |
| 000110 | Subcarriers 0, 1, 2, 3, | 011100 | Subcarriers 0, 1, and |
| | 4, and 5 in the PRB | | 2 in the PRB m5 |
| | m4 | | |
| 000111 | Subcarriers 6, 7, 8, 9, | 011101 | Subcarriers 3, 4, and |
| | 10, and 11 in the | | 5 in the PRB m5 |
| | PRB m4 | | |
| 001000 | Subcarriers 0, 1, 2, 3, | 011110 | Subcarriers 6, 7, and |
| | 4, and 5 in the PRB | | 8 in the PRB m5 |
| | m5 | | |
| 001001 | Subcarriers 6, 7, 8, 9, | 011111 | Subcarriers 9, 10, and |
| | 10, and 11 in the | | 11 in the PRB m5 |
| | PRB m5 | | |
| 001010 | Subcarriers 0, 1, 2, 3, | 100000 | Subcarriers 0, 1, and |
| | 4, and 5 in the PRB | | 2 in the PRB m6 |
| | m6 | | |
| 001011 | Subcarriers 6, 7, 8, 9, | 100001 | Subcarriers 3, 4, and |
| | 10, and 11 in the | | 5 in the PRB m6 |
| | PRB m6 | | |
| 001100 | Subcarriers 0, 1, and | 100010 | Subcarriers 6, 7, and |
| | 2 in the PRB m1 | | 8 in the PRB m6 |
| 001101 | Subcarriers 3, 4, and | 100011 | Subcarriers 9, 10, and |
| | 5 in the PRB m1 | | 11 in the PRB m6 |
| 001110 | Subcarriers 6, 7, and | 100100 | PRB n |
| | 8 in the PRB m1 | | |
| 001111 | Subcarriers 9, 10, | 100101 | PRB n + 1 |
| | and 11 in the PRB | | |
| | m1 | | |
| 010000 | Subcarriers 0, 1, and | 100110 | PRB n + 2 |
| | 2 in the PRB m2 | | |
| 010001 | Subcarriers 3, 4, and | 100111 | PRB n + 3 |
| | 5 in the PRB m2 | | |
| 010010 | Subcarriers 6, 7, and | 101000 | PRB n + 4 |
| | 8 in the PRB m2 | | |
| 010011 | Subcarriers 9, 10, | 101001 | PRB n + 5 |
| | and 11 in the PRB | | |
| | m2 | | |
| 010100 | Subcarriers 0, 1, and | 101010 | PRB n and PRB n + 1 |
| | 2 in the PRB m3 | | |
| 010101 | Subcarriers 3, 4, and | 101011 | PRB n + 2 and PRB |
| | 5 in the PRB m3 | | n + 3 |

It should be noted that Table 13 to Table 16 are merely examples for description, the six types indicate resource allocation of one PRB in the narrowband, the two types indicate resource allocation of two PRBs in the narrowband, the eight types indicate resource allocation of six subcarriers in one of four PRBs configured by using the higher layer signaling, and the 16 types indicate resource allocation of three subcarriers in one of the four PRBs configured by using the higher layer signaling. The resource allocation may be alternatively indicated based on another mapping relationship.

In a fifth possible implementation, for a terminal device in a coverage enhancement mode A, an example in which the resource allocation information includes

$$⌈ {log}_{2} ⌊ \frac{{N}_{R B}^{U L}}{6} ⌋ ⌉ + 6$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes six bits, and the six bits have 64 bit states, where the 64 bit states include 21 bit states, and the 21 bit states indicate, to user equipment, a resource allocation granularity of one resource block and resource allocation in the narrowband; and/or the 64 bit states further include 12 bit states, each of the 12 bit states indicates that six subcarriers in a physical resource block m are allocated to the user equipment, and the physical resource block m is a resource block in the narrowband; and/or the 64 bit states further include 24 bit states, each of the 24 bit states indicates that three subcarriers in a physical resource block x are allocated to the user equipment, and the physical resource block x is a resource block in the narrowband.

For example, a mapping relationship between the 32 bit states and a resource allocation may alternatively meet Table 17. In Table 17, a PRB n, a PRB n+1, a PRB n+2, a PRB n+3, a PRB n+4, and a PRB n+5 are six consecutive PRBs in the narrowband. Herein, n is an integer greater than or equal to 0; and n, n+1, n+2, n+3, n+4, and n+5 represent indexes of PRBs. In Table 17, an RIV value corresponds to a start resource block RB_{START} included in a PUSCH frequency resource and a quantity L_{CRBs} of consecutive resource blocks. The RIV is defined as follows: if (L_{CRBs}−1)≤└N_{RB}^{UL}/2┘, RIV=N_{RB}^{UL}(L_{CRBs}−1)+RB_{START}; or otherwise, RIV=N_{RB}^{UL}(N_{RB}^{UL}−L_{CRBs}+1)+(N_{RB}^{UL}−1−RB_{START}), where N_{RB}^{UL} is fixed to 6, and the PUSCH frequency resource corresponding to the RIV value is a resource in the narrowband. In Table 17, n is an integer greater than or equal to 0; and n, n+1, n+2, n+3, n+4, and n+5 represent indexes of PRBs.

TABLE 17

| States | | States | |
|---|---|---|---|
| indicated | | indicated | |
| by six | | by six | |
| bits | Allocated resource | bits | Allocated resource |
| 000000 | RIV = 0 | 011101 | Subcarriers 6, 7, and 8 |
| | | | in the PRB n + 1 |
| 000001 | RIV = 1 | 011110 | Subcarriers 9, 10, and |
| | | | 11 in the PRB n + 1 |
| 000010 | RIV = 2 | 011111 | Subcarriers 0, 1, 2, 3, |
| | | | 4, and 5 in the PRB |
| | | | n + 1 |
| 000011 | RIV = 3 | 100000 | Subcarriers 6, 7, 8, 9, |
| | | | 10, and 11 in the PRB |
| | | | n + 1 |
| 000100 | RIV = 4 | 100001 | Subcarriers 0, 1, and 2 |
| | | | in the PRB n + 2 |
| 000101 | RIV = 5 | 100010 | Subcarriers 3, 4, and 5 |
| | | | in the PRB n + 2 |
| 000110 | RIV = 6 | 100011 | Subcarriers 6, 7, and 8 |
| | | | in the PRB n + 2 |
| 000111 | RIV = 7 | 100100 | Subcarriers 9, 10, and |
| | | | 11 in the PRB n + 2 |
| 001000 | RIV = 8 | 100101 | Subcarriers 0, 1, 2, 3, |
| | | | 4, and 5 in the PRB |
| | | | n + 2 |
| 001001 | RIV = 9 | 100110 | Subcarriers 6, 7, 8, 9, |
| | | | 10, and 11 in the PRB |
| | | | n + 2 |
| 001010 | RIV = 10 | 100111 | Subcarriers 0, 1, and 2 |
| | | | in the PRB n + 3 |
| 001011 | RIV = 11 | 101000 | Subcarriers 3, 4, and 5 |
| | | | in the PRB n + 3 |
| 001100 | RIV = 12 | 101001 | Subcarriers 6, 7, and 8 |
| | | | in the PRB n + 3 |
| 001101 | RIV = 13 | 101010 | Subcarriers 9, 10, and |
| | | | 11 in the PRB n + 3 |
| 001110 | RIV = 14 | 101011 | Subcarriers 0, 1, 2, 3, |
| | | | 4, and 5 in the PRB |
| | | | n + 3 |
| 001111 | RIV = 15 | 101100 | Subcarriers 6, 7, 8, 9, |
| | | | 10, and 11 in the PRB |
| | | | n + 3 |
| 010000 | RIV = 16 | 101101 | Subcarriers 0,1, and 2 |
| | | | in the PRB n + 4 |
| 010001 | RIV = 17 | 101110 | Subcarriers 3, 4, and 5 |
| | | | in the PRB n + 4 |
| 010010 | RIV = 18 | 101111 | Subcarriers 6, 7, and 8 |
| | | | in the PRB n + 4 |
| 010011 | RIV = 19 | 110000 | Subcarriers 9, 10, and |
| | | | 11 in the PRB n + 4 |
| 010100 | RIV = 20 | 110001 | Subcarriers 0, 1, 2, 3, |
| | | | 4, and 5 in the PRB |
| | | | n + 4 |
| 010101 | Subcarriers 0, 1, | 110010 | Subcarriers 6, 7, 8, 9, |
| | and 2 in the PRB n | | 10, and 11 in the PRB |
| | n + 4 | | |
| 010110 | Subcarriers 3,4, | 110011 | Subcarriers 0,1, and 2 |
| | and 5 in the PRB n | | in the PRB n + 5 |
| 010111 | Subcarriers 6, 7, | 110100 | Subcarriers 3, 4, and 5 |
| | and 8 in the PRB n | | in the PRB n + 5 |
| 011000 | Subcarriers 9, 10, | 110101 | Subcarriers 6, 7, and 8 |
| | and 11 in the PRB n | | in the PRB n + 5 |
| 011001 | Subcarriers 0, 1, 2, | 110110 | Subcarriers 9, 10, and |
| | 3, 4, and 5 in the | | 11 in the PRB n + 5 |
| | PRB n | | |
| 011010 | Subcarriers 6, 7, 8, | 110111 | Subcarriers 0, 1, 2, 3, |
| | 9,10, and 11 in the | | 4, and 5 in the PRB |
| | PRB n | | n + 5 |
| 011011 | Subcarriers 0, 1, | 111000 | Subcarriers 6, 7, 8, 9, |
| | and 2 in the PRB | | 10, and 11 in the PRB |
| | n + 1 | | n + 5 |
| 011100 | Subcarriers 3, 4, | | |
| | and 5 in the PRB | | |
| | n + 1 | | |

For example, a mapping relationship between the 32 bit states and a resource allocation may alternatively meet Table 18. A PRB n, a PRB n+1, a PRB n+2, a PRB n+3, a PRB n+4, and a PRB n+5 are six consecutive PRBs in the narrowband. Herein, n is an integer greater than or equal to 0; and n, n+1, n+2, n+3, n+4, and n+5 represent indexes of PRBs. In Table 18, an RIV value corresponds to a start resource block RB_{START} included in a PUSCH frequency resource and a quantity L_{CRBs} of consecutive resource blocks. The RIV is defined as follows: if (L_{CRBs}−1)≤└N_{RB}^{UL}┘, RIV=N_{RB}^{UL}(L_{CRBs}−1)+RB_{START}; or otherwise, RIV=N_{RB}^{UL} (N_{RB}^{UL}−L_{CRBs}+1)+(N_{RB}^{UL}−1−RB_{START}), where N_{RB}^{UL} is fixed to 6, and the PUSCH frequency resource corresponding to the RIV value is a resource in the narrowband. In Table 18, n is an integer greater than or equal to 0; and n, n+1, n+2, n+3, n+4, and n+5 represent indexes of PRBs.

TABLE 18

| States | | States | |
|---|---|---|---|
| indicated | | indicated | |
| by six | | by six | |
| bits | Allocated resource | bits | Allocated resource |
| 000000 | Subcarriers 0, 1, and 2 | 011101 | Subcarriers 6, 7, 8, |
| | in the PRB n | | 9,10, and 11 in the |
| | | | PRB n + 4 |
| 000001 | Subcarriers 3, 4, and 5 | 011110 | Subcarriers 0, 1, |
| | in the PRB n | | and 2 in the PRB |
| | | | n + 5 |
| 000010 | Subcarriers 6, 7, and 8 | 011111 | Subcarriers 3, 4, |
| | in the PRB n | | and 5 in the PRB |
| | | | n + 5 |
| 000011 | Subcarriers 9, 10, and | 100000 | Subcarriers 6, 7, |
| | 11 in the PRB n | | and 8 in the PRB |
| | | | n + 5 |
| 000100 | Subcarriers 0, 1, 2, 3, 4, | 100001 | Subcarriers 9, 10, |
| | and 5 in the PRB n | | and 11 in the PRB |
| | | | n + 5 |
| 000101 | Subcarriers 6, 7, 8, 9, | 100010 | Subcarriers 0, 1, 2, |
| | 10, and 11 in the PRB n | | 3, 4, and 5 in the |
| | | | PRB n + 5 |
| 000110 | Subcarriers 0, 1, and 2 | 100011 | Subcarriers 6, 7, 8, |
| | in the PRB n + 1 | | 9, 10, and 11 in the |
| | PRB n + 5 | | |
| 000111 | Subcarriers 3, 4, and 5 | 100100 | RIV = 0 |
| | in the PRB n + 1 | | |
| 001000 | Subcarriers 6, 7, and 8 | 100101 | RIV = 1 |
| | in the PRB n + 1 | | |
| 001001 | Subcarriers 9, 10, and | 100110 | RIV = 2 |
| | 11 in the PRB n + 1 | | |
| 001010 | Subcarriers 0, 1, 2, 3, 4, | 100111 | RIV = 3 |
| | and 5 in the PRB n + 1 | | |
| 001011 | Subcarriers 6, 7, 8, 9, | 101000 | RIV = 4 |
| | 10, and 11 in the PRB | | |
| | n + 1 | | |
| 001100 | Subcarriers 0, 1, and 2 | 101001 | RIV = 5 |
| | in the PRB n + 2 | | |
| 001101 | Subcarriers 3, 4, and 5 | 101010 | RIV = 6 |
| | in the PRB n + 2 | | |
| 001110 | Subcarriers 6, 7, and 8 | 101011 | RIV = 7 |
| | in the PRB n + 2 | | |
| 001111 | Subcarriers 9, 10, and | 101100 | RIV = 8 |
| | 11 in the PRB n + 2 | | |
| 010000 | Subcarriers 0, 1, 2, 3, 4, | 101101 | RIV = 9 |
| | and 5 in the PRB n + 2 | | |
| 010001 | Subcarriers 6, 7, 8, 9, | 101110 | RIV = 10 |
| | 10, and 11 in the PRB | | |
| | n + 2 | | |
| 010010 | Subcarriers 0, 1, and 2 | 101111 | RIV = 11 |
| | in the PRB n + 3 | | |
| 010011 | Subcarriers 3, 4, and 5 | 110000 | RIV = 12 |
| | in the PRB n + 3 | | |
| 010100 | Subcarriers 6, 7, and 8 | 110001 | RIV = 13 |
| | in the PRB n + 3 | | |
| 010101 | Subcarriers 9, 10, and | 110010 | RIV = 14 |
| | 11 in the PRB n + 3 | | |
| 010110 | Subcarriers 0, 1, 2, 3, 4, | 110011 | RIV = 15 |
| | and 5 in the PRB n + 3 | | |
| 010111 | Subcarriers 6, 7, 8, 9, | 110100 | RIV = 16 |
| | 10, and 11 in the PRB | | |
| | n + 3 | | |
| 011000 | Subcarriers 0, 1, and 2 | 110101 | RIV = 17 |
| | in the PRB n + 4 | | |
| 011001 | Subcarriers 3, 4, and 5 | 110110 | RIV = 18 |
| | in the PRB n + 4 | | |
| 011010 | Subcarriers 6, 7, and 8 | 110111 | RIV = 19 |
| | in the PRB n + 4 | | |
| 011011 | Subcarriers 9, 10, and | 111000 | RIV = 20 |
| | 11 in the PRB n + 4 | | |
| 011100 | Subcarriers 0, 1, 2, 3, 4, | | |
| | and 5 in the PRB n + 4 | | |

For example, a mapping relationship between the 32 bit states and a resource allocation may alternatively meet Table 19. A PRB n, a PRB n+1, a PRB n+2, a PRB n+3, a PRB n+4, and a PRB n+5 are six consecutive PRBs in the narrowband. Herein, n is an integer greater than or equal to 0; and n, n+1, n+2, n+3, n+4, and n+5 represent indexes of PRBs. In Table 19, an RIV value corresponds to a start resource block RB_{START} included in a PUSCH frequency resource and a quantity L_{CRBs} of consecutive resource blocks. The RIV is defined as follows: if (L_{CRBs}−1)≤└N_{RB}^{UL}┘, RIV=N_{RB}^{UL}(L_{CRBs}−1)+RB_{START}; or otherwise, RIV=N_{RB}^{UL} (N_{RB}^{UL}−L_{CRBs}+1)+(N_{RB}^{UL}−1−RB_{START}), where N_{RB}^{UL} is fixed to 6, and the PUSCH frequency resource corresponding to the RIV value is a resource in the narrowband. In Table 19, n is an integer greater than or equal to 0; and n, n+1, n+2, n+3, n+4, and n+5 represent indexes of PRBs.

TABLE 19

| States | | States | |
|---|---|---|---|
| indicated | | indicated | |
| by six | | by | |
| bits | Allocated resource | six bits | Allocated resource |
| 000000 | RIV = 0 | 011101 | Subcarriers 0, 1, 2, 3, |
| | | | 4, and 5 in the PRB |
| | | | n + 4 |
| 000001 | RIV = 1 | 011110 | Subcarriers 6, 7, 8, 9, |
| | | | 10, and 11 in the PRB |
| | | | n + 4 |
| 000010 | RIV = 2 | 011111 | Subcarriers 0, 1, 2, 3, |
| | | | 4, and 5 in the PRB |
| | | | n + 5 |
| 000011 | RIV = 3 | 100000 | Subcarriers 6, 7, 8, 9, |
| | | | 10, and 11 in the PRB |
| | | | n + 5 |
| 000100 | RIV = 4 | 100001 | Subcarriers 0, 1, and |
| | | | 2 in the PRB n |
| 000101 | RIV = 5 | 100010 | Subcarriers 3, 4, and |
| | | | 5 in the PRB n |
| 000110 | RIV = 6 | 100011 | Subcarriers 6, 7, and |
| | | | 8 in the PRB n |
| 000111 | RIV = 7 | 100100 | Subcarriers 9, 10, and |
| | | | 11 in the PRB n |
| 001000 | RIV = 8 | 100101 | Subcarriers 0, 1, and |
| | | | 2 in the PRB n + 1 |
| 001001 | RIV = 9 | 100110 | Subcarriers 3, 4, and |
| | | | 5 in the PRB n + 1 |
| 001010 | RIV = 10 | 100111 | Subcarriers 6, 7, and |
| | | | 8 in the PRB n + 1 |
| 001011 | RIV = 11 | 101000 | Subcarriers 9, 10, and |
| | | | 11 in the PRB n + 1 |
| 001100 | RIV = 12 | 101001 | Subcarriers 0, 1, and |
| | | | 2 in the PRB n + 2 |
| 001101 | RIV = 13 | 101010 | Subcarriers 3, 4, and |
| | | | 5 in the PRB n + 2 |
| 001110 | RIV = 14 | 101011 | Subcarriers 6,7, and |
| | | | 8 in the PRB n + 2 |
| 001111 | RIV = 15 | 101100 | Subcarriers 9, 10, and |
| | | | 11 in the PRB n + 2 |
| 010000 | RIV = 16 | 101101 | Subcarriers 0, 1, and |
| | | | 2 in the PRB n + 3 |
| 010001 | RIV = 17 | 101110 | Subcarriers 3, 4, and |
| | | | 5 in the PRB n + 3 |
| 010010 | RIV = 18 | 101111 | Subcarriers 6, 7, and |
| | | | 8 in the PRB n + 3 |
| 010011 | RIV = 19 | 110000 | Subcarriers 9, 10, and |
| | | | 11 in the PRB n + 3 |
| 010100 | RIV = 20 | 110001 | Subcarriers 0, 1, and |
| | | | 2 in the PRB n + 4 |
| 010101 | Subcarriers 0, 1, 2, 3, 4, | 110010 | Subcarriers 3, 4, and |
| | and 5 in the PRB n | | 5 in the PRB n + 4 |
| 010110 | Subcarriers 6, 7, 8, 9, 10, | 110011 | Subcarriers 6, 7, and |
| | and 11 in the PRB n | | 8 in the PRB n + 4 |
| 010111 | Subcarriers 0, 1, 2, 3, 4, | 110100 | Subcarriers 9, 10, and |
| | and 5 in the PRB n + 1 | | 11 in the PRB n + 4 |
| 011000 | Subcarriers 6, 7, 8, 9, 10, | 110101 | Subcarriers 0, 1, and |
| | and 11 in the PRB n + 1 | | 2 in the PRB n + 5 |
| 011001 | Subcarriers 0, 1, 2, 3, 4, | 110110 | Subcarriers 3, 4, and |
| | and 5 in the PRB n + 2 | | 5 in the PRB n + 5 |
| 011010 | Subcarriers 6, 7, 8, 9, 10, | 110111 | Subcarriers 6, 7, and |
| | and 11 in the PRB n + 2 | | 8 in the PRB n + 5 |
| 011011 | Subcarriers 0, 1, 2, 3, 4, | 111000 | Subcarriers 9, 10, and |
| | and 5 in the PRB n + 3 | | 11 in the PRB n + 5 |
| 011100 | Subcarriers 6, 7, 8, 9, 10, | 100100 | |
| | and 11 in the PRB n + 3 | | |

For example, a mapping relationship between the 32 bit states and a resource allocation may alternatively meet Table 20. A PRB n, a PRB n+1, a PRB n+2, a PRB n+3, a PRB n+4, and a PRB n+5 are six consecutive PRBs in the narrowband. Herein, n is an integer greater than or equal to 0; and n, n+1, n+2, n+3, n+4, and n+5 represent indexes of PRBs. In Table 20, an RIV value corresponds to a start resource block RB_{START} included in a PUSCH frequency resource and a quantity L_{CRBs} of consecutive resource blocks. The RIV is defined as follows: if (L_{CRBs}−1)≤└N_{RB}^{UL}┘, RIV=N_{RB}^{UL}(L_{CRBs}−1)+RB_{START}; or otherwise, RIV=N_{RB}^{UL} (N_{RB}^{UL}−L_{CRBs}+1)+(N_{RB}^{UL}−1−RB_{START}), where N_{RB}^{UL} is fixed to 6, and the PUSCH frequency resource corresponding to the RIV value is a resource in the narrowband. In Table 20, n is an integer greater than or equal to 0; and n, n+1, n+2, n+3, n+4, and n+5 represent indexes of PRBs.

TABLE 20

| States | | States | |
|---|---|---|---|
| indicated | | indicated | |
| by six | | by | |
| bits | Allocated resource | six bits | Allocated resource |
| 000000 | Subcarriers 0, 1, 2, 3, 4, | 011101 | Subcarriers 3, 4, and |
| | and 5 in the PRB n | | 5 in the PRB n + 4 |
| 000001 | Subcarriers 6, 7, 8, 9, 10, | 011110 | Subcarriers 6, 7, and |
| | and 11 in the PRB n | | 8 in the PRB n + 4 |
| 000010 | Subcarriers 0, 1, 2, 3, 4, | 011111 | Subcarriers 9, 10, and |
| | and 5 in the PRB n + 1 | | 11 in the PRB n + 4 |
| 000011 | Subcarriers 6, 7, 8, 9, 10, | 100000 | Subcarriers 0, 1, and |
| | and 11 in the PRB n + 1 | | 2 in the PRB n + 5 |
| 000100 | Subcarriers 0, 1, 2, 3, 4, | 100001 | Subcarriers 3, 4, and |
| | and 5 in the PRB n + 2 | | 5 in the PRB n + 5 |
| 000101 | Subcarriers 6, 7, 8, 9, 10, | 100010 | Subcarriers 6, 7, and |
| | and 11 in the PRB n + 2 | | 8 in the PRB n + 5 |
| 000110 | Subcarriers 0, 1, 2, 3, 4, | 100011 | Subcarriers 9, 10, and |
| | and 5 in the PRB n + 3 | | 11 in the PRB n + 5 |
| 000111 | Subcarriers 6, 7, 8, 9, 10, | 100100 | RIV = 0 |
| | and 11 in the PRB n + 3 | | |
| 001000 | Subcarriers 0, 1, 2, 3, 4, | 100101 | RIV = 1 |
| | and 5 in the PRB n + 4 | | |
| 001001 | Subcarriers 6, 7, 8, 9, 10, | 100110 | RIV = 2 |
| | and 11 in the PRB n + 4 | | |
| 001010 | Subcarriers 0, 1, 2, 3, 4, | 100111 | RIV = 3 |
| | and 5 in the PRB n + 5 | | |
| 001011 | Subcarriers 6, 7, 8, 9, 10, | 101000 | RIV = 4 |
| | and 11 in the PRB n + 5 | | |
| 001100 | Subcarriers 0, 1, and 2 in | 101001 | RIV = 5 |
| | the PRB n | | |
| 001101 | Subcarriers 3, 4, and 5 in | 101010 | RIV = 6 |
| | the PRB n | | |
| 001110 | Subcarriers 6, 7, and 8 in | 101011 | RIV = 7 |
| | the PRB n | | |
| 001111 | Subcarriers 9, 10, and 11 | 101100 | RIV = 8 |
| | in the PRB n | | |
| 010000 | Subcarriers 0, 1, and 2 in | 101101 | RIV = 9 |
| | the PRB n + 1 | | |
| 010001 | Subcarriers 3, 4, and 5 in | 101110 | RIV = 10 |
| | the PRB n + 1 | | |
| 010010 | Subcarriers 6, 7, and 8 in | 101111 | RIV = 11 |
| | the PRB n + 1 | | |
| 010011 | Subcarriers 9, 10, and 11 | 110000 | RIV = 12 |
| | in the PRB n + 1 | | |
| 010100 | Subcarriers 0, 1, and 2 in | 110001 | RIV = 13 |
| | the PRB n + 2 | | |
| 010101 | Subcarriers 3,4, and 5 in | 110010 | RIV = 14 |
| | the PRB n + 2 | | |
| 010110 | Subcarriers 6, 7, and 8 in | 110011 | RIV = 15 |
| | the PRB n + 2 | | |
| 010111 | Subcarriers 9, 10, and 11 | 110100 | RIV = 16 |
| | in the PRB n + 2 | | |
| 011000 | Subcarriers 0, 1, and 2 in | 110101 | RIV = 17 |
| | the PRB n + 3 | | |
| 011001 | Subcarriers 3, 4, and 5 in | 110110 | RIV = 18 |
| | the PRB n + 3 | | |
| 011010 | Subcarriers 6, 7, and 8 in | 110111 | RIV = 19 |
| | the PRB n + 3 | | |
| 011011 | Subcarriers 9, 10, and 11 | 111000 | RIV = 20 |
| | in the PRB n + 3 | | |
| 011100 | Subcarriers 0, 1, and 2 in | 100100 | |
| | the PRB n + 4 | | |

It should be noted that Table 17 to Table 20 are merely examples for description, the six types indicate resource allocation of one PRB in the narrowband, the two types indicate resource allocation of two PRBs in the narrowband, the eight types indicate resource allocation of six subcarriers in one of four PRBs configured by using the higher layer signaling, and the 16 types indicate resource allocation of three subcarriers in one of the four PRBs configured by using the higher layer signaling. The resource allocation may be alternatively indicated based on another mapping relationship.

In a sixth possible implementation, for a terminal device in a coverage enhancement mode A, an example in which the resource allocation information includes

$$⌈ {log}_{2} ⌊ \frac{{N}_{RB}^{UL}}{6} ⌋ ⌉ + 6$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes six bits, and the six bits have 64 bit states, where the 64 bit states include 21 bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and the 21 bit states indicate, to user equipment, a resource allocation granularity of one resource block and resource allocation in the narrowband; and/or the 64 bit states further include 12 bit states, each of the 12 bit states indicates that six subcarriers in a physical resource block k are allocated to the user equipment, the physical resource block k is one of six physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 24 bit states, each of the 24 bit states indicates that three subcarriers in a physical resource blocky are allocated to the user equipment, the physical resource blocky is one of the six physical resource blocks configured by using the higher layer signaling, the resource allocation information further includes

$$⌈ {log}_{2} ⌊ \frac{{N}_{RB}^{UL}}{6} ⌋ ⌉$$

bits, and states of

$$⌈ {log}_{2} ⌊ \frac{{N}_{RB}^{UL}}{6} ⌋ ⌉$$

the bits are set to all ones or all zeros. Herein, N_{RB}^{UL} represents a quantity of uplink RBs corresponding to a system bandwidth, ┌ ┐ represents rounding up, and represents rounding down.

For example, a mapping relationship between the 32 bit states and a resource allocation may alternatively meet Table 17 to Table 20. A PRB n, a PRB n+1, a PRB n+2, a PRB n+3, a PRB n+4, and a PRB n+5 are any six PRBs in the system bandwidth that are configured by using the higher layer signaling.

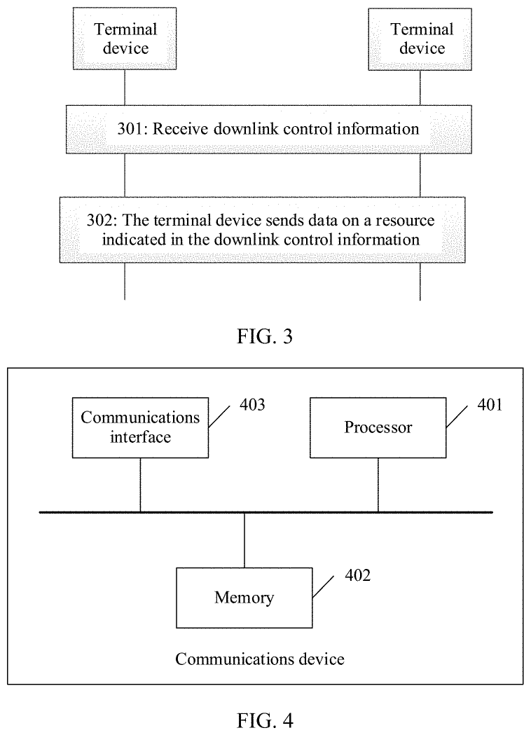

FIG. 3 is a schematic flowchart of a resource allocation method according to an embodiment of this application. As shown in FIG. 3, the resource allocation method includes the following operations 301 to 302.

301: A terminal device receives downlink control information.

302: The terminal device sends data on a resource indicated in the downlink control information.

It should be noted that in an embodiment of the application, because the downlink control information includes indication information and resource allocation information, after the terminal device receives the downlink control information, a network device may determine, in the following at least two possible implementations, the indication information and the resource allocation information included in the downlink control information.

In a first possible implementation, for a terminal device in a coverage enhancement mode B, an example in which the resource allocation information includes

$$⌈ {log}_{2} ⌊ \frac{{N}_{RB}^{UL}}{6} ⌋ ⌉ + 5$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes five bits, and the five bits have 32 bit states, where the 32 bit states include six bit states, and each of the six bit states indicates that one resource block in the narrowband is allocated to the terminal device; and/or the 32 bit states further include two bit states, and each of the two bit states indicates that two resource blocks in the narrowband are allocated to the terminal device; and/or the 32 bit states further include eight bit states, each of the eight bit states indicates that six subcarriers in a physical resource block m are allocated to the terminal device, and the physical resource block m is one of four physical resource blocks configured by using higher layer signaling; and/or the 32 bit states further include 16 bit states, each of the 16 bit states indicates that three subcarriers in a physical resource block x are allocated to the terminal device, and the physical resource block x is one of the four physical resource blocks configured by using the higher layer signaling.

Optionally, the four physical resource blocks configured by using the higher layer signaling are four physical resource blocks in the narrowband.

It can be learned that the network device indicates, by using the

$$⌈ {log}_{2} ⌊ \frac{{N}_{RB}^{UL}}{6} ⌋ ⌉$$

bits, a location that is of the allocated resource and that is in the narrowband, and then indicates the 32 bit states by using the other five bits. The 32 bit states correspond to six states about allocating one resource block, two states about allocating two resource blocks, eight states about allocating six subcarriers, and 16 states about allocating three subcarriers.

For example, a mapping relationship between the 32 bit states and a resource allocation may meet Table 1. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are four resource blocks that are configured by using the higher layer signaling and that are in the PRB n, the PRB n+1, the PRB n+2, the PRB n+3, the PRB n+4, and the PRB n+5.

For example, a mapping relationship between the 32 bit states and a resource allocation may alternatively meet Table 2. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are four resource blocks that are configured by using the higher layer signaling and that are in the PRB n, the PRB n+1, the PRB n+2, the PRB n+3, the PRB n+4, and the PRB n+5.

For example, a mapping relationship between the 32 bit states and a resource allocation may alternatively meet Table 3. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are four resource blocks that are configured by using the higher layer signaling and that are in the PRB n, the PRB n+1, the PRB n+2, the PRB n+3, the PRB n+4, and the PRB n+5.

For example, a mapping relationship between the 32 bit states and a resource allocation may alternatively meet Table 4. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are four resource blocks that are configured by using the higher layer signaling and that are in the PRB n, the PRB n+1, the PRB n+2, the PRB n+3, the PRB n+4, and the PRB n+5.

It should be noted that Table 1 to Table 4 are merely examples for description, the six types indicate resource allocation of one PRB in the narrowband, the two types indicate resource allocation of two PRBs in the narrowband, the eight types indicate resource allocation of six subcarriers in one of four PRBs configured by using the higher layer signaling, and the 16 types indicate resource allocation of three subcarriers in one of the four PRBs configured by using the higher layer signaling. The resource allocation may be alternatively indicated based on another mapping relationship.

In a second possible implementation, for a terminal device in a coverage enhancement mode B, an example in which the resource allocation information includes

$$⌈ {log}_{2} ⌊ \frac{{N}_{RB}^{UL}}{6} ⌋ ⌉ + 5$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes five bits, and the five bits have 32 bit states, where the 32 bit states include six bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the six bit states indicates that one resource block in the narrowband is allocated to user equipment; and/or the 32 bit states further include two bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the two bit states indicates that two resource blocks in the narrowband are allocated to the user equipment; and/or the 32 bit states further include eight bit states, each of the eight bit states indicates that six subcarriers in a physical resource block m are allocated to the user equipment, the physical resource block m is one of four physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 16 bit states, each of the 16 bit states indicates that three subcarriers in a physical resource block x are allocated to the user equipment, the physical resource block x is one of the four physical resource blocks configured by using the higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros. Herein, N_{RB}^{UL} represents a quantity of uplink RBs corresponding to a system bandwidth, ┌ ┐ represents rounding up, and └ ┘ represents rounding down.

Optionally, the four physical resource blocks configured by using the higher layer signaling are any four physical resource blocks configured in the system bandwidth.

For example, a mapping relationship between the 32 bit states and a resource allocation may meet Table 5. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are any four resource blocks in the system bandwidth that are configured by using the higher layer signaling.

For example, a mapping relationship between the 32 bit states and a resource allocation may alternatively meet Table 6. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are any four resource blocks in the system bandwidth that are configured by using the higher layer signaling.

For example, a mapping relationship between the 32 bit states and a resource allocation may alternatively meet Table 7. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are any four resource blocks in the system bandwidth that are configured by using the higher layer signaling.

For example, a mapping relationship between the 32 bit states and a resource allocation may alternatively meet Table 8. A PRB n, a PRB n+1, a PRB n+2, a PRB n+3, a PRB n+4, and a PRB n+5 are six consecutive PRBs in the narrowband. A PRB m1, a PRB m2, a PRB m3, and a PRB m4 are any four resource blocks in the system bandwidth that are configured by using the higher layer signaling.

It should be noted that Table 5 to Table 8 are merely examples for description, the six types indicate resource allocation of one PRB in the narrowband, the two types indicate resource allocation of two PRBs in the narrowband, the eight types indicate resource allocation of six subcarriers in one of four PRBs configured by using the higher layer signaling, and the 16 types indicate resource allocation of three subcarriers in one of the four PRBs configured by using the higher layer signaling. The resource allocation may be alternatively indicated based on another mapping relationship.

In a third possible implementation, for a terminal device in a coverage enhancement mode B, an example in which the resource allocation information includes

$$⌈ {log}_{2} ⌊ \frac{{N}_{RB}^{UL}}{6} ⌋ ⌉ + 6$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes six bits, and the six bits have 64 bit states, where the 64 bit states include six bit states, and each of the six bit states indicates that one resource block in the narrowband is allocated to user equipment; and/or the 64 bit states further include two bit states, and each of the two bit states indicates that two resource blocks in the narrowband are allocated to the user equipment; and/or the 64 bit states further include 12 bit states, each of the 12 bit states indicates that six subcarriers in a physical resource block k are allocated to the user equipment, and the physical resource block k is a resource block in the narrowband; and/or the 64 bit states further include 24 bit states, each of the 24 bit states indicates that three subcarriers in a physical resource block p are allocated to the user equipment, and the physical resource block p is a resource block in the narrowband.

For example, a mapping relationship between the 32 bit states and a resource allocation may alternatively meet Table 9. A PRB n, a PRB n+1, a PRB n+2, a PRB n+3, a PRB n+4, and a PRB n+5 are six consecutive PRBs in the narrowband.

For example, a mapping relationship between the 32 bit states and a resource allocation may alternatively meet Table 10. A PRB n, a PRB n+1, a PRB n+2, a PRB n+3, a PRB n+4, and a PRB n+5 are six consecutive PRBs in the narrowband.

For example, a mapping relationship between the 32 bit states and a resource allocation may alternatively meet Table 11. A PRB n, a PRB n+1, a PRB n+2, a PRB n+3, a PRB n+4, and a PRB n+5 are six consecutive PRBs in the narrowband.

For example, a mapping relationship between the 32 bit states and a resource allocation may alternatively meet Table 12. A PRB n, a PRB n+1, a PRB n+2, a PRB n+3, a PRB n+4, and a PRB n+5 are six consecutive PRBs in the narrowband.

It should be noted that Table 9 to Table 12 are merely examples for description, the six types indicate resource allocation of one PRB in the narrowband, the two types indicate resource allocation of two PRBs in the narrowband, the 12 types indicate resource allocation of six subcarriers in one of six PRBs configured by using the higher layer signaling, and the 24 types indicate resource allocation of three subcarriers in one of the six PRBs configured by using the higher layer signaling. The resource allocation may be alternatively indicated based on another mapping relationship.

In a fourth possible implementation, for a terminal device in a coverage enhancement mode B, an example in which the resource allocation information includes

$$⌈ {log}_{2} ⌊ \frac{{N}_{RB}^{UL}}{6} ⌋ ⌉ + 6$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information further includes six bits, and the six bits have 64 bit states, where the 64 bit states include six bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the six bit states indicates that one resource block in the narrowband is allocated to user equipment; and/or the 64 bit states further include two bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and each of the two bit states indicates that two resource blocks in the narrowband are allocated to the user equipment; and/or the 64 bit states further include 12 bit states, each of the 12 bit states indicates that six subcarriers in a physical resource block k are allocated to the user equipment, the physical resource block k is one of six physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 24 bit states, each of the 24 bit states indicates that three subcarriers in a physical resource block y are allocated to the user equipment, the physical resource block y is one of the six physical resource blocks configured by using the higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros. Herein, N_{RB}^{UL} represents a quantity of uplink RBs corresponding to a system bandwidth, ┌ ┐ represents rounding up, and └ ┘ represents rounding down.

Optionally, the six physical resource blocks configured by using the higher layer signaling are any six physical resource blocks configured in the system bandwidth.

For example, a mapping relationship between the 32 bit states and a resource allocation may alternatively meet Table 13. A PRB n, a PRB n+1, a PRB n+2, a PRB n+3, a PRB n+4, and a PRB n+5 are six consecutive PRBs in the narrowband. A PRB m1, a PRB m2, a PRB m3, a PRB m4, a PRB m5, and a PRB m6 are any six physical resource blocks in the system bandwidth that are configured by using the higher layer signaling.

For example, a mapping relationship between the 32 bit states and a resource allocation may alternatively meet Table 14. A PRB n, a PRB n+1, a PRB n+2, a PRB n+3, a PRB n+4, and a PRB n+5 are six consecutive PRBs in the narrowband. A PRB m1, a PRB m2, a PRB m3, a PRB m4, a PRB m5, and a PRB m6 are any six physical resource blocks in the system bandwidth that are configured by using the higher layer signaling.

For example, a mapping relationship between the 32 bit states and a resource allocation may alternatively meet Table 15. A PRB n, a PRB n+1, a PRB n+2, a PRB n+3, a PRB n+4, and a PRB n+5 are six consecutive PRBs in the narrowband. A PRB m1, a PRB m2, a PRB m3, a PRB m4, a PRB m5, and a PRB m6 are any six physical resource blocks in the system bandwidth that are configured by using the higher layer signaling.

For example, a mapping relationship between the 32 bit states and a resource allocation may alternatively meet Table 16. A PRB n, a PRB n+1, a PRB n+2, a PRB n+3, a PRB n+4, and a PRB n+5 are six consecutive PRBs in the narrowband. A PRB m1, a PRB m2, a PRB m3, a PRB m4, a PRB m5, and a PRB m6 are any six physical resource blocks in the system bandwidth that are configured by using the higher layer signaling.

It should be noted that Table 13 to Table 16 are merely examples for description, the six types indicate resource allocation of one PRB in the narrowband, the two types indicate resource allocation of two PRBs in the narrowband, the 12 types indicate resource allocation of six subcarriers in one of six PRBs configured by using the higher layer signaling, and the 24 types indicate resource allocation of three subcarriers in one of the four PRBs configured by using the higher layer signaling. The resource allocation may be alternatively indicated based on another mapping relationship.

In a fifth possible implementation, for a terminal device in a coverage enhancement mode A, an example in which the resource allocation information includes

$$⌈ {log}_{2} ⌊ \frac{{N}_{RB}^{UL}}{6} ⌋ ⌉ + 6$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, N_{RB}^{UL} represents a quantity of uplink RBs corresponding to a system bandwidth, ┌ ┐ represents rounding up, and └ ┘ represents rounding down. The resource allocation information further includes six bits, and the six bits have 64 bit states, where the 64 bit states include 21 bit states, and the 21 bit states indicate, to user equipment, a resource allocation granularity of one resource block and resource allocation in the narrowband; and/or the 64 bit states further include 12 bit states, each of the 12 bit states indicates that six subcarriers in a physical resource block m are allocated to the user equipment, and the physical resource block m is a resource block in the narrowband; and/or the 64 bit states further include 24 bit states, each of the 24 bit states indicates that three subcarriers in a physical resource block x are allocated to the user equipment, and the physical resource block x is a resource block in the narrowband.

For example, a mapping relationship between the 32 bit states and a resource allocation may alternatively meet Table 17. A PRB n, a PRB n+1, a PRB n+2, a PRB n+3, a PRB n+4, and a PRB n+5 are six consecutive PRBs in the narrowband.

For example, a mapping relationship between the 32 bit states and a resource allocation may alternatively meet Table 18. A PRB n, a PRB n+1, a PRB n+2, a PRB n+3, a PRB n+4, and a PRB n+5 are six consecutive PRBs in the narrowband.

For example, a mapping relationship between the 32 bit states and a resource allocation may alternatively meet Table 19. A PRB n, a PRB n+1, a PRB n+2, a PRB n+3, a PRB n+4, and a PRB n+5 are six consecutive PRBs in the narrowband.

For example, a mapping relationship between the 32 bit states and a resource allocation may alternatively meet Table 20. A PRB n, a PRB n+1, a PRB n+2, a PRB n+3, a PRB n+4, and a PRB n+5 are six consecutive PRBs in the narrowband.

It should be noted that Table 17 to Table 20 are merely examples for description, the six types indicate resource allocation of one PRB in the narrowband, the two types indicate resource allocation of two PRBs in the narrowband, the 12 types indicate resource allocation of six subcarriers in one of six PRBs configured by using the higher layer signaling, and the 24 types indicate resource allocation of three subcarriers in one of the six PRBs configured by using the higher layer signaling. The resource allocation may be alternatively indicated based on another mapping relationship.

In a sixth possible implementation, for a terminal device in a coverage enhancement mode A, an example in which the resource allocation information includes

$$⌈ {log}_{2} ⌊ \frac{{N}_{RB}^{UL}}{6} ⌋ ⌉ + 6$$

bits is used for description. The network device determines the resource allocation information in the downlink control information based on the resource allocated to the terminal device. The network device sends the determined downlink control information to the terminal device. The network device receives, on the resource allocated to the terminal device, the data sent by the terminal device.

Optionally, the resource allocation information includes six bits, and the six bits have 64 bit states, where the 64 bit states include 21 bit states, the resource allocation information further includes

$$⌈ {log}_{2} ⌊ \frac{{N}_{RB}^{UL}}{6} ⌋ ⌉$$

bits, the

$$⌈ {log}_{2} ⌊ \frac{{N}_{RB}^{UL}}{6} ⌋ ⌉$$

bits indicate a narrowband, and the 21 bit states indicate, to user equipment, a resource allocation granularity of one resource block and resource allocation in the narrowband; and/or the 64 bit states further include 12 bit states, each of the 12 bit states indicates that six subcarriers in a physical resource block k are allocated to the user equipment, the physical resource block k is one of six physical resource blocks configured by using higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros; and/or the 32 bit states further include 24 bit states, each of the 24 bit states indicates that three subcarriers in a physical resource blocky are allocated to the user equipment, the physical resource blocky is one of the six physical resource blocks configured by using the higher layer signaling, the resource allocation information further includes

$$⌈ {log}_{2} ⌊ \frac{{N}_{RB}^{UL}}{6} ⌋ ⌉$$

bits, and states of the

$$⌈ {log}_{2} ⌊ \frac{{N}_{RB}^{UL}}{6} ⌋ ⌉$$

bits are set to all ones or all zeros. Herein, N_{RB}^{UL} represents a quantity of uplink RBs corresponding to a system bandwidth, ┌ ┐ represents rounding up, and └ ┘ represents rounding down.

For example, a mapping relationship between the 32 bit states and a resource allocation may alternatively meet Table 17 to Table 20. A PRB n, a PRB n+1, a PRB n+2, a PRB n+3, a PRB n+4, and a PRB n+5 are any six PRBs in the system bandwidth that are configured by using the higher layer signaling.

It should be noted that Table 17 to Table 20 are merely examples for description, the six types indicate resource allocation of one PRB in the narrowband, the two types indicate resource allocation of two PRBs in the narrowband, the 12 types indicate resource allocation of six subcarriers in one of six PRBs configured by using the higher layer signaling, and the 24 types indicate resource allocation of three subcarriers in one of the six PRBs configured by using the higher layer signaling. The resource allocation may be alternatively indicated based on another mapping relationship.

FIG. 4 is a schematic structural diagram of a network device according to an embodiment of this application. As shown in FIG. 4, the network device 400 includes a processor 401, a memory 402, and a communications interface 403. The processor 401, the memory 402, and the communications interface 403 are connected to each other.

The processor 401 may be a central processing unit (CPU), a general-purpose processor, a digital signal processor (DSP), an application-specific integrated circuit (ASIC), a field programmable gate array (FPGA), or another programmable logic device, a transistor logic device, a hardware component, or any combination thereof. Alternatively, the processor 401 may be a combination of processors implementing a computing function, for example, a combination of one or more microprocessors, or a combination of the DSP and a microprocessor.

The communications interface 403 is configured to communicate with another network element (for example, a terminal device).

The processor 401 invokes program code stored in the memory 402, to perform the operations performed by the network device described in the foregoing method embodiments.

Based on a same inventive concept, a problem-resolving principle of the network device provided in an embodiment of the application is similar to that of the method embodiments of this application. Therefore, for implementation of each device, refer to implementation of the method. Details are not described herein again for brevity.

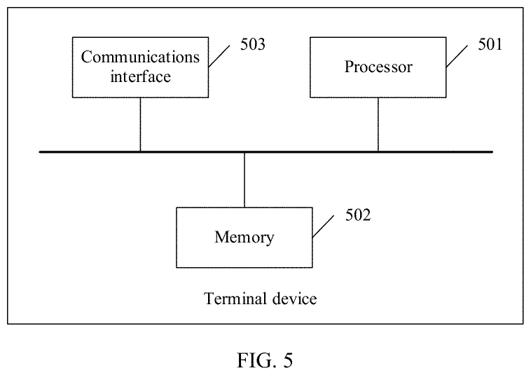

FIG. 5 is a schematic structural diagram of a terminal device according to an embodiment of this application. As shown in FIG. 5, the terminal device 500 includes a processor 501, a memory 502, and a communications interface 503. The processor 501, the memory 502, and the communications interface 503 are connected to each other.

The processor 501 may be a central processing unit (CPU), a general-purpose processor, a digital signal processor (DSP), an application-specific integrated circuit (ASIC), a field programmable gate array (FPGA), or another programmable logic device, a transistor logic device, a hardware component, or any combination thereof. Alternatively, the processor 501 may be a combination of processors implementing a computing function, for example, a combination of one or more microprocessors, or a combination of the DSP and a microprocessor.

The communications interface 503 is configured to communicate with another network element (for example, a network device).

The processor 501 invokes program code stored in the memory 502, to perform the operations performed by the terminal device in the foregoing method embodiments.

Based on a same inventive concept, a problem-resolving principle of the terminal device provided in an embodiment of the application is similar to that of the method embodiments of this application. Therefore, for implementation of each device, refer to implementation of the method. Details are not described herein again for brevity.

It may be understood that when the embodiments of this application are applied to a chip of the network device, the chip of the network device implements functions of the network device in the foregoing method embodiments. The chip of the network device sends first information to another module (for example, a radio frequency module or an antenna) of the network device, and receives second information from the another module of the network device. The first information is sent to the terminal device through the another module of the network device, and the second information is sent by the terminal device to the network device. When the embodiments of this application are applied to a chip of the terminal device, the chip of the terminal device implements functions of the terminal device in the foregoing method embodiments. The chip of the terminal device receives the first information from another module (for example, a radio frequency module or an antenna) of the terminal device, and sends the second information to the another module of the terminal device. The first information is sent by the network device to the terminal device, and the second information is sent to the network device. The first information and the second information herein are not a particular type of information, but are merely used to indicate a communication mode between the chip and the another module.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable apparatuses. The computer instruction may be stored in a computer readable storage medium, or may be transmitted by using the computer readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

In the foregoing embodiments, the description of each embodiment has respective focuses. For a part that is not described in detail in an embodiment, refer to related descriptions in other embodiments.

Finally, it should be noted that the foregoing embodiments are merely intended for describing the technical solutions of this application other than limiting this application. Although this application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of this application.

1. A resource allocation method, comprising:
determining, by a network device, a downlink control information, wherein
the downlink control information comprises a resource allocation information, and the resource allocation information indicates a resource allocated to a terminal device;
sending, by the network device, the downlink control information to the terminal device; and
receiving, by the network device on the resource allocated to the terminal device, data sent by the terminal device.

2. The method according to claim 1, wherein
the resource allocation information comprises
$$⌈ {log}_{2} ⌊ \frac{{N}_{RB}^{UL}}{6} ⌋ ⌉$$
bits, the
$$⌈ {log}_{2} ⌊ \frac{{N}_{R B}^{U L}}{6} ⌋ ⌉$$
bits indicate a narrowband, N_{RB}^{UL} represents a quantity of uplink resource blocks (RBs) corresponding to a system bandwidth, ┌ ┐ represents rounding up, and └ ┘ represents rounding down; and
the resource allocation information further comprises five bits, and the five bits have 32 bit states, wherein the 32 bit states comprise six bit states, and each of the six bit states indicates that one resource block in the narrowband is allocated to the terminal device;
wherein the 32 bit states comprise two bit states, and each of the two bit states indicates that two resource blocks in the narrowband are allocated to the terminal device;
wherein the 32 bit states comprise eight bit states, each of the eight bit states indicates that six subcarriers in a physical resource block m are allocated to the terminal device, and the physical resource block m is one of four physical resource blocks configured by using higher layer signaling;
wherein the 32 bit states comprise 16 bit states, each of the 16 bit states indicates that three subcarriers in a physical resource block x are allocated to the terminal device, and the physical resource block x is one of the four physical resource blocks configured by using the higher layer signaling,
or any combination thereof.

3. The method according to claim 1, wherein the resource allocation information comprises five bits, and the five bits have 32 bit states, wherein
the 32 bit states comprise six bit states, the resource allocation information further comprises
$$⌈ {log}_{2} ⌊ \frac{{N}_{R B}^{U L}}{6} ⌋ ⌉$$
bits, the
$$⌈ {log}_{2} ⌊ \frac{{N}_{R B}^{U L}}{6} ⌋ ⌉$$
bits indicate a narrowband, and each of the six bit states indicates that one resource block in the narrowband is allocated to user equipment;
wherein the 32 bit states comprise two bit states, the resource allocation information further comprises
$$⌈ {log}_{2} ⌊ \frac{{N}_{R B}^{U L}}{6} ⌋ ⌉$$
bits, the
$$⌈ {log}_{2} ⌊ \frac{{N}_{R B}^{U L}}{6} ⌋ ⌉$$
bits indicate a narrowband, and each of the two bit states indicates that two resource blocks in the narrowband are allocated to the user equipment;
wherein the 32 bit states comprise eight bit states, each of the eight bit states indicates that six subcarriers in a physical resource block m are allocated to the user equipment, the physical resource block m is one of four physical resource blocks configured by using higher layer signaling, the resource allocation information further comprises
$$⌈ {log}_{2} ⌊ \frac{{N}_{R B}^{U L}}{6} ⌋ ⌉$$
bits, and states of the
$$⌈ {log}_{2} ⌊ \frac{{N}_{R B}^{U L}}{6} ⌋ ⌉$$
bits are set to all ones or all zeros;
wherein the 32 bit states comprise 16 bit states, each of the 16 bit states indicates that three subcarriers in a physical resource block x are allocated to the user equipment, the physical resource block x is one of the four physical resource blocks configured by using the higher layer signaling, the resource allocation information further comprises
$$⌈ {log}_{2} ⌊ \frac{{N}_{R B}^{U L}}{6} ⌋ ⌉$$
bits, and states of the
$$⌈ {log}_{2} ⌊ \frac{{N}_{R B}^{U L}}{6} ⌋ ⌉$$
bits are set to all ones or all zeros,
or any combination thereof; and
N_{RB}^{UL} represents a quantity of uplink RBs corresponding to a system bandwidth, ┌ ┐ represents rounding up, and ┌ ┐ represents rounding down.

4. The method according to claim 1, wherein
the resource allocation information comprises
$$⌈ {log}_{2} ⌊ \frac{{N}_{R B}^{U L}}{6} ⌋ ⌉$$
bits, the
$$⌈ {log}_{2} ⌊ \frac{{N}_{R B}^{U L}}{6} ⌋ ⌉$$
bits indicate a narrowband, N_{RB}^{UL} represents a quantity of uplink resource blocks (RBs) corresponding to a system bandwidth, ┌ ┐ represents rounding up, and └ ┘ represents rounding down; and
the resource allocation information further comprises six bits, and the six bits have 64 bit states, wherein
the 64 bit states comprise six bit states, and each of the six bit states indicates that one resource block in the narrowband is allocated to user equipment;
wherein the 64 bit states comprise two bit states, and each of the two bit states indicates that two resource blocks in the narrowband are allocated to the user equipment;
wherein the 64 bit states comprise 12 bit states, each of the 12 bit states indicates that six subcarriers in a physical resource block k are allocated to the user equipment, and the physical resource block k is a resource block in the narrowband;
wherein the 64 bit states comprise 24 bit states, each of the 24 bit states indicates that three subcarriers in a physical resource block p are allocated to the user equipment, and the physical resource block p is a resource block in the narrowband,
or any combination thereof.

5. The method according to claim 1, wherein
the resource allocation information further comprises six bits, and the six bits have 64 bit states, wherein the 64 bit states comprise six bit states, the resource allocation information further comprises
$$⌈ {log}_{2} ⌊ \frac{{N}_{R B}^{U L}}{6} ⌋ ⌉$$
bits, the
$$⌈ {log}_{2} ⌊ \frac{{N}_{R B}^{U L}}{6} ⌋ ⌉$$
bits indicate a narrowband, and each of the six bit states indicates that one resource block in the narrowband is allocated to user equipment;
wherein the 64 bit states comprise two bit states, the resource allocation information further comprises
$$⌈ {log}_{2} ⌊ \frac{{N}_{R B}^{U L}}{6} ⌋ ⌉$$
bits, the
$$⌈ {log}_{2} ⌊ \frac{{N}_{R B}^{U L}}{6} ⌋ ⌉$$
bits indicate a narrowband, and each of the two bit states indicates that two resource blocks in the narrowband are allocated to the user equipment;
wherein the 64 bit states comprise 12 bit states, each of the 12 bit states indicates that six subcarriers in a physical resource block k are allocated to the user equipment, the physical resource block k is one of six physical resource blocks configured by using higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros;
wherein the 64 bit states comprise 24 bit states, each of the 24 bit states indicates that three subcarriers in a physical resource block y are allocated to the user equipment, the physical resource block y is one of the six physical resource blocks configured by using the higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros,
or any combination thereof; and
N_{RB}^{UL} represents a quantity of uplink RBs corresponding to a system bandwidth, ┌ ┐ represents rounding up, and └ ┘ represents rounding down.

6. The method according to claim 1, wherein
the resource allocation information comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, N_{RB}^{UL} represents a quantity of uplink RBs corresponding to a system bandwidth, ┌ ┐ represents rounding up, and └ ┘ represents rounding down; and
the resource allocation information further comprises six bits, and the six bits have 64 bit states, wherein the 64 bit states comprise 21 bit states, and the 21 bit states indicate, to user equipment, a resource allocation granularity of one resource block and resource allocation in the narrowband;
wherein the 64 bit states comprise 12 bit states, each of the 12 bit states indicates that six subcarriers in a physical resource block m are allocated to the user equipment, and the physical resource block m is a resource block in the narrowband;
wherein the 64 bit states comprise 24 bit states, each of the 24 bit states indicates that three subcarriers in a physical resource block x are allocated to the user equipment, and the physical resource block x is a resource block in the narrowband,
or any combination thereof.

7. The method according to claim 1, wherein
the resource allocation information comprises six bits, and the six bits have 64 bit states, wherein
the 64 bit states comprise 21 bit states, the resource allocation information further comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and the 21 bit states indicate, to user equipment, a resource allocation granularity of one resource block and resource allocation in the narrowband;
wherein the 64 bit states comprise 12 bit states, each of the 12 bit states indicates that six subcarriers in a physical resource block k are allocated to the user equipment, the physical resource block k is one of six physical resource blocks configured by using higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros;
wherein the 64 bit states comprise 24 bit states, each of the 24 bit states indicates that three subcarriers in a physical resource block y are allocated to the user equipment, the physical resource block y is one of the six physical resource blocks configured by using the higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros, or
any combination thereof; and
N_{RB}^{UL} represents a quantity of uplink RBs corresponding to a system bandwidth, ┌ ┐ represents rounding up, and └ ┘ represents rounding down.

8. A resource allocation method, comprising:
receiving, by a terminal device, a downlink control information, wherein
the downlink control information comprises a resource allocation information, and the resource allocation information indicates a resource allocated to the terminal device; and
sending, by the terminal device, data on the resource indicated in the downlink control information.

9. The method according to claim 8, wherein
the resource allocation information comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, N_{RB}^{UL} represents a quantity of uplink resource blocks (RBs), corresponding to a system bandwidth, ┌ ┐ represents rounding up, and └ ┘ represents rounding down; and
the resource allocation information further comprises five bits, and the five bits have 32 bit states, wherein
the 32 bit states comprise six bit states, and each of the six bit states indicates that one resource block in the narrowband is allocated to the terminal device;
wherein the 32 bit states comprise two bit states, and each of the two bit states indicates that two resource blocks in the narrowband are allocated to the terminal device;
wherein the 32 bit states comprise eight bit states, each of the eight bit states indicates that six subcarriers in a physical resource block m are allocated to the terminal device, and the physical resource block m is one of four physical resource blocks configured by using higher layer signaling;
wherein the 32 bit states further comprise 16 bit states, each of the 16 bit states indicates that three subcarriers in a physical resource block x are allocated to the terminal device, and the physical resource block x is one of the four physical resource blocks configured by using the higher layer signaling,
or any combination thereof.

10. The method according to claim 8, wherein
the resource allocation information comprises five bits, and the five bits have 32 bit states, wherein
the 32 bit states comprise six bit states, the resource allocation information further comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and each of the six bit states indicates that one resource block in the narrowband is allocated to user equipment;
wherein the 32 bit states comprise two bit states, the resource allocation information further comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and each of the two bit states indicates that two resource blocks in the narrowband are allocated to the user equipment;
wherein the 32 bit states comprise eight bit states, each of the eight bit states indicates that six subcarriers in a physical resource block m are allocated to the user equipment, the physical resource block m is one of four physical resource blocks configured b using higher layer signaling, the resource allocation information further comprise
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros;
wherein the 32 bit states comprise 16 bit states, each of the 16 bit states indicates that three subcarriers in a physical resource block x are allocated to the user equipment, the physical resource block x is one of the four physical resource blocks configured by using the higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros,
or any combination thereof; and
N_{RB}^{UL} represents a quantity of uplink RBs corresponding to a system bandwidth, ┌ ┐ represents rounding up, and └ ┘ represents rounding down.

11. The method according to claim 8, wherein
the resource allocation information comprise
$$⌈ {log}_{2} ⌊ \frac{{N}_{RB}^{UL}}{6} ⌋ ⌉$$
bits, and the
$$⌈ {log}_{2} ⌊ \frac{{N}_{RB}^{UL}}{6} ⌋ ⌉$$
bits indicate a narrowband; and
the resource allocation information further comprises six bits, and the six bits have 64 bit states, wherein
the 64 bit states comprise six bit states, and each of the six bit states indicates that one resource block in the narrowband is allocated to user equipment;
wherein the 64 bit states further comprise two bit states, and each of the two bit states indicates that two resource blocks in the narrowband are allocated to the user equipment;
wherein the 64 bit states further comprise 12 bit states, each of the 12 bit states indicates that six subcarriers in a physical resource block k are allocated to the user equipment, and the physical resource block k is a resource block in the narrowband;
wherein the 64 bit states further comprise 24 bit states, each of the 24 bit states indicates that three subcarriers in a physical resource block p are allocated to the user equipment, and the physical resource block p is a resource block in the narrowband, or any combination thereof.

12. The method according to claim 8, wherein
the resource allocation information further comprises six bits, and the six bits have 64 bit states, wherein
the 64 bit states comprise six bit states, the resource allocation information further comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and each of the six bit states indicates that one resource block in the narrowband is allocated to user equipment;
wherein the 64 bit states comprise two bit states, the resource allocation information further comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and each of the two bit states indicates that two resource blocks in the narrowband are allocated to the user equipment;
wherein the 64 bit states comprise 12 bit states, each of the 12 bit states indicates that six subcarriers in a physical resource block k are allocated to the user equipment, the physical resource block k is one of six physical resource blocks configured by using higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros;
wherein the 64 bit states comprise 24 bit states, each of the 24 bit states indicates that three subcarriers in a physical resource block y are allocated to the user equipment, the physical resource block y is one of the six physical resource blocks configured by using the higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros,
or any combination thereof; and
N_{RB}^{UL} represents a quantity of uplink RBs corresponding to a system bandwidth, ┌ ┐ represents rounding up, and └ ┘ represents rounding down.

13. The method according to claim 8, wherein
the resource allocation information comprises
$$⌈ {log}_{2} ⌊ \frac{{N}_{RB}^{UL}}{6} ⌋ ⌉$$
bits, and the
$$⌈ {log}_{2} ⌊ \frac{{N}_{RB}^{UL}}{6} ⌋ ⌉$$
bits indicate a narrowband; and
the resource allocation information further comprises six bits, and the six bits have 64 bit states, wherein
the 64 bit states comprise 21 bit states, and the 21 bit states indicate, to user equipment, a resource allocation granularity of one resource block and resource allocation in the narrowband;
wherein the 64 bit states comprise 12 bit states, each of the 12 bit states indicates that six subcarriers in a physical resource block m are allocated to the user equipment, and the physical resource block m is a resource block in the narrowband;
wherein the 64 bit states comprise 24 bit states, each of the 24 bit states indicates that three subcarriers in a physical resource block x are allocated to the user equipment, and the physical resource block x is a resource block in the narrowband;
or any combination thereof.

14. The method according to claim 8, wherein
the resource allocation information comprises six bits, and the six bits have 64 bit states, wherein
the 64 bit states comprise 21 bit states, the resource allocation information further comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and the 21 bit states indicate, to user equipment, a resource allocation granularity of one resource block and resource allocation in the narrowband;
wherein the 64 bit states comprise 12 bit states, each of the 12 bit states indicates that six subcarriers in a physical resource block m are allocated to the user equipment, the physical resource block k is one of six physical resource blocks configured by using higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros;
wherein the 64 bit states comprise 24 bit states, each of the 24 bit states indicates that three subcarriers in a physical resource block m are allocated to the user equipment, the physical resource block y is one of the six physical resource blocks configured b using the higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros,
or any combination thereof.

15. A network device, wherein the network device comprises:
a processor, configured to determine a downlink control information, wherein
the downlink control information comprises a resource allocation information, and the resource allocation information indicates a resource allocated to a terminal device; and
a transceiver, configured to send the downlink control information to the terminal device, wherein
the transceiver receives, on the resource allocated to the terminal device, data sent by the terminal device.

16. The device according to claim 15, wherein
the resource allocation information comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, N_{RB}^{UL} represents a quantity of uplink resource block (RBs) corresponding to a system bandwidth, ┌ ┐ represents rounding up, and └ ┘ represents rounding down; and
the resource allocation information further comprises five bits, and the five bits have 32 bit states, wherein
the 32 bit states comprise six bit states, and each of the six bit states indicates that one resource block in the narrowband is allocated to the terminal device;
wherein the 32 bit states comprise two bit states, and each of the two bit states indicates that two resource blocks in the narrowband are allocated to the terminal device;
wherein the 32 bit states comprise eight bit states, each of the eight bit states indicates that six subcarriers in a physical resource block m are allocated to the terminal device, and the physical resource block m is one of four physical resource blocks configured by using higher layer signaling;
wherein the 32 bit states comprise 16 bit states, each of the 16 bit states indicates that three subcarriers in a physical resource block x are allocated to the terminal device, and the physical resource block x is one of the four physical resource blocks configured by using the higher layer signaling,
or any combination thereof.

17. The device according to claim 15, wherein
the resource allocation information comprises five bits, and the five bits have 32 bit states, wherein
the 32 bit states comprise six bit states, the resource allocation information further comprise
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and each of the six bit states indicates that one resource block in the narrowband is allocated to user equipment;
wherein the 32 bit states comprise two bit states, the resource allocation information further comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and each of the two bit states indicates that two resource blocks in the narrowband are allocated to the user equipment;
wherein the 32 bit states comprise eight bit states, each of the eight bit states indicates that six subcarriers in a physical resource block m are allocated to the user equipment, the physical resource block m is one of four physical resource blocks configured by using higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros;
wherein the 32 bit states comprise 16 bit states, each of the 16 bit states indicates that three subcarriers in a physical resource block x are allocated to the user equipment, the physical resource block x is one of the four physical resource blocks configured by using the higher layer signaling, the resource allocation information further comprise
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros,
or any combination thereof; and
N_{RB}^{UL} represents a quantity of uplink RBs corresponding to a system bandwidth, ┌ ┐ represents rounding up, and └ ┘ represents rounding down.

18. A terminal device, wherein the terminal device comprises:
a transceiver, configured to receive a downlink control information; and
a processor, configured to determine a resource allocation information indicated in the downlink control information, wherein
the downlink control information comprises the resource allocation information, and the resource allocation information indicates a resource allocated to the terminal device.

19. The device cording to claim 18, wherein
the resource allocation information comprise
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, N_{RB}^{UL} represents a quantity of uplink resource blocks (RBs) corresponding to a system bandwidth, ┌ ┐ represents rounding up, and └ ┘ represents rounding down; and
the resource allocation information further comprises five bits, and the five bits have 32 bit states, wherein
the 32 bit states comprise six bit states, and each of the six bit states indicates that one resource block in the narrowband is allocated to the terminal device;
wherein the 32 bit states comprise two bit states, and each of the two bit states indicates that two resource blocks in the narrowband are allocated to the terminal device;
wherein the 32 bit states comprise eight bit states, each of the eight bit states indicates that six subcarriers in a physical resource block m are allocated to the terminal device, and the physical resource block m is one of four physical resource blocks configured by using higher layer signaling;
wherein the 32 bit states comprise 16 bit states, each of the 16 bit states indicates that three subcarriers in a physical resource block x are allocated to the terminal device, and the physical resource block x is one of the four physical resource blocks configured by using the higher layer signaling, or any combination thereof.

20. The device according to claim 18, wherein
the resource allocation information comprises five bits, and the five bits have 32 bit states, wherein
the 32 bit states comprise six bit states, the resource allocation information further comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and each of the six bit states indicates that one resource block in the narrowband is allocated to user equipment;
wherein the 32 bit states comprise two bit states, the resource allocation information further comprises
$$⌈ {log}_{2} ⌊ \frac{{N}_{RB}^{UL}}{6} ⌋ ⌉$$
bits, the
$$⌈ {log}_{2} ⌊ \frac{{N}_{RB}^{UL}}{6} ⌋ ⌉$$
bits indicate a narrowband, and each of the two bit states indicates that two resource blocks in the narrowband are allocated to the user equipment;
wherein the 32 bit states comprise eight bit states, each of the eight bit states indicates that six subcarriers in a physical resource block m are allocated to the user equipment, the physical resource block m is one of four physical resource blocks configured by using higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros;
wherein the 32 bit states comprise 16 bit states, each of the 16 bit states indicates that three subcarriers in a physical resource block x are allocated to the user equipment, the physical resource block x is one of the four physical resource blocks configured by using the higher layer signaling, the resource allocation information further comprises
$$⌈ {log}_{2} ⌊ \frac{{N}_{RB}^{UL}}{6} ⌋ ⌉$$
bits, and states of the
$$⌈ {log}_{2} ⌊ \frac{{N}_{RB}^{UL}}{6} ⌋ ⌉$$
bits are set to all ones or all zeros,
or any combination thereof; and
N_{RB}^{UL} represents a quantity of uplink RBs corresponding to a system bandwidth, ┌ ┐ represents rounding up, and ┌ ┐ represents rounding down.
